(19) United States
(12) Patent Application Publication
(10) Pub. No.: US 2013/0336637 A1
(43) Pub. Date: Dec. 19, 2013

(54) INFORMATION PROCESSING DEVICE AND INFORMATION PROCESSING METHOD, COMPUTER PROGRAM, AND INFORMATION COMMUNICATION SYSTEM

(71) Applicant: Sony Corporation, Tokyo (JP)

(72) Inventors: JUNICHI NAKAMURA, Chiba (JP); HIDEKI SATO, Kanagawa (JP)

(73) Assignee: Sony Corporation, Tokyo (JP)

(21) Appl. No.: 13/899,276

(22) Filed: May 21, 2013

(30) Foreign Application Priority Data
Jun. 15, 2012 (JP) 2012-136383

(51) Int. Cl. H04N 9/87

(52) U.S. Cl. CPC H04N 9/87
USPC 386/262

(57) ABSTRACT

There is provided an information processing device including an account registration unit that registers account information of a user and account information of a group that includes a plurality of users, a metadata retaining unit that retains information of a terminal that the user or the group uses and reproduction stop position information of content in association with the account information of the user or the group, and a metadata providing unit that provides the terminal that the user or the group uses with the reproduction stop position information associated with the account information of the user or the group.

### BACKGROUND

The present disclosure relates to an information processing device and an information processing method, a computer program, and an information communication system that are used by each of a plurality of users to reproduce content such as moving images, music, electronic books, and photos (slide shows) in their information terminals or AV devices under a network environment within, for example, a household, and particularly to an information processing device and an information processing method, a computer program, and an information communication system that realize continuous reproduction of content simultaneously used by a plurality of users.

In recent years, households having home networks constructed therewithin using wireless or wired LANs (Local Area Networks) have increased. On such a home network, family members can enjoy content such as moving images and music accumulated in one content server using their own respective reproducing devices. The reproducing devices referred to herein include personal computers, multifunctional terminals such as tablet PCs and mobile telephones, and AV devices such as television receiver sets.

There are many cases in which a user who was viewing content pauses viewing to do other business and then resumes viewing the content when he or she is free. In such cases, information on the position at which the reproduction was previously stopped is important for the user in order to view the rest of the content with no omissions of the content or overlap in the reproduced range. When a medium such as a DVD is loaded on a specific reproducing device for viewing, it is easy for the reproducing device to be set to hold the position at which the reproduction previously was stopped. On the other hand, when reproduction of the content of which viewing content has been paused is to be resumed under an environment in which content accumulated in a household content server is reproduced, there is a problem in that there is a possibility of positions desired to be reproduced again being different depending on users, as well as devices to be used in reproduction changing.

For example, a display system and a household server in which reproduction stop position information of video content is shared between different reproducing devices by identifying users, and then reproduction of the rest of the content is realized has been proposed (for example, refer to Japanese Unexamined Patent Application Publication No. 2009-94814). However, this system fails to provide for a case in which a plurality of users simultaneously use video content, and thus it is considered to be necessary for the system to be carefully used by focusing on which user is using video content as a representing user. In addition, the system also fails to provide for a case in which a plurality of users simultaneously use video content and then only some of the users pause viewing, and thus there is a possibility of the users who paused viewing missing reproduction stop position information. In addition, since the household server is configured to provide a function of identifying content corresponding to reproduction stop position information, the use of reproduction stop position information is limited to content managed by the household server.

In addition, a content reproducing device that executes resuming reproduction of content from a stop position by managing metadata when reproduction of content acquired from communication and broadcasting is stopped, and a history has been proposed (for example, refer to Japanese Unexamined Patent Application Publication No. 2011-146879). However, this content reproduction devices fails to assume a case in which a plurality of users simultaneously use content, and to clarify how reproduction stop position information is managed when only some of the users pause viewing.

In addition, an information processing system in which content on a server is reproduced by a device, and the same content is reproduced from a point by another device located in another place has been proposed (for example, refer to Japanese Unexamined Patent Application Publication No. 2011-35695). While this information processing system assumes that there is a gap between locations and times in previous and current viewing, it fails to assume that a plurality of users simultaneously use the content, and to clarify how continuous reproduction is performed when only some of the users pause viewing.

In addition, a content distribution system in which a server side manages reproduction stop position information for respective user terminals, and starts reproduction from a position at which previous viewing is stopped using the reproduction stop position information when a user terminal starts a VOD service again has been proposed (for example, refer to Japanese Unexamined Patent Application Publication No. 2005-269411). According to this system, while the reproduction stop position information can be managed separately for each user, it is unclear how continuous reproduction is performed when a plurality of users simultaneously use content, and then only some of the users pause viewing.

### SUMMARY

It is desirable for the technology disclosed in the present specification to provide an excellent information processing device and information processing method, computer program, and information communication system that can satisfactorily realize continuous reproduction of content used by a plurality of users at the same time.

It is further desirable for the technology disclosed in the present specification to provide an excellent information processing device and information processing method, computer program, and information communication system that can satisfactorily realize continuous reproduction even when a plurality of users use content at the same time, and then only some of the users pause viewing.

According to an embodiment of the present disclosure, there is provided an information processing device including an account registration unit that registers account information of a user and account information of a group that includes a plurality of users, a metadata retaining unit that retains information of a terminal that the user or the group uses and reproduction stop position information of content in association with the account information of the user or the group, and a metadata providing unit that provides the terminal that the user or the group uses with the reproduction stop position information associated with the account information of the user or the group.

According to the embodiment of the present disclosure, the metadata retaining unit may be configured to retain reproduction stop position information received from a terminal that logs in using account information of an individual user in association with the account information of the user, and to retain reproduction stop position information received from a terminal that logs in using account information of a group in association with the account information of the group.

According to the embodiment of the present disclosure, the metadata providing unit may be configured to provide a terminal that logs in using account information of an individual user with reproduction stop position information associated with the account information of the individual user and reproduction stop position information of a group (or a plurality of groups) associated with the account information of the individual user.

According to the embodiment of the present disclosure, the metadata providing unit may be configured to provide a terminal that logs in using account information of a group with reproduction stop position information associated with the account information of the group, reproduction stop position information of an individual user (or a plurality of individual users) associated with the group, and reproduction stop position information of another group (or a plurality of other groups) further associated with the individual user who is associated with the group.

According to the embodiment of the present disclosure, the metadata retaining unit may be configured to retain reproduction stop position information along with information on a place of origin of content.

In addition, according to another embodiment of the present disclosure, there is provided an information processing device including a content reproduction unit that reproduces content, a user detection unit that detects a user, a registration unit that registers the user detected by the user detection unit in a metadata server to acquire account information, a reproduction stop position information registration unit that logs into the metadata server using the account information of the user to register reproduction stop position information of the content of the content reproduction unit in association with the account information, and a reproduction stop position information acquisition unit that logs into the metadata server using the account information of the user to acquire the reproduction stop position information of the content associated with the account information. The content reproduction unit reproduces the content from a beginning position or the acquired reproduction stop position.

According to the embodiment of the present disclosure, the registration unit may be configured to register a plurality of users detected by the user detection unit in the metadata server as a group to acquire account information of the group.

According to the embodiment of the present disclosure, the reproduction stop position information acquisition unit may be configured to log into the metadata server using account information of an individual user to acquire reproduction stop position information associated with the account information of the individual user and reproduction stop position information of a group (or a plurality of groups) associated with the account information of the individual user.

According to the embodiment of the present disclosure, the reproduction stop position information acquisition unit may be configured to log into the metadata server using account information of a group to acquire reproduction stop position information associated with the account information of the group, reproduction stop position information of an individual user (or a plurality of individual users) associated with the group, and reproduction stop position information of another group (or a plurality of other groups) further associated with the individual user who is associated with the group.

According to the embodiment of the present disclosure, the reproduction stop position information registration unit may be configured to log into the metadata server using account information of a group to register reproduction stop position information in association with the account information of the group in response to a top of reproduction of content that has been viewed and listened to by the group.

According to the embodiment of the present disclosure, in response to the user detection unit detecting that a user who is a member of a group is leaving, the reproduction stop position information registration unit may be configured to log into the metadata server using account information of the user who is leaving to register reproduction position information at a time of leaving as reproduction stop position information in association with the account information of the user who is leaving.

According to the embodiment of the present disclosure, in response to the user detection unit detecting absence of all users of a group, the reproduction stop position information registration unit may be configured to log into the metadata server using account information of the group to register reproduction position information at a time when the absence of all the users is detected as reproduction stop position information in association with the account information of the group.

According to the embodiment of the present disclosure, while logging into the metadata server using account information of a group, in response to control by a terminal that an individual user who belongs to the group uses, the group may be configured to be logged out from the metadata server, and to log into the metadata server again using account information of the individual user.

According to the embodiment of the present disclosure, in response to a content reproduction request received from a terminal that an individual user who belongs to a group uses, the reproduction stop position information acquisition unit may be configured to log into the metadata server using account information of the individual user to acquire reproduction stop position information of content associated with the account information of the individual user.

According to the embodiment of the present disclosure, in response to a content reproduction stop request received from a terminal that an individual user who belongs to a group uses, the reproduction stop position information registration unit may be configured to log into the metadata server using account information of the individual user to register reproduction stop position information of content in association with the account information of the individual user.

According to the embodiment of the present disclosure, the reproduction stop position information acquisition unit may be configured to acquire reproduction stop position information along with information on a place of origin of content. The content reproduction unit configured to identify content and then continuously reproduces the content from a reproduction stop position using the acquired information on a place of origin.

In addition, according to still another embodiment of the present disclosure, there is provided an information processing method including registering account information of a user and account information of a group that includes a plurality of users, retaining information of a terminal that the user or the group uses and reproduction stop position information of content in association with account information of the user or the group, and providing the terminal that the user or the group uses with reproduction stop position information associated with the account information of the user or the group.

In addition, according to still another embodiment of the present disclosure, there is provided an information processing method including reproducing content, detecting a user, registering the user detected in the user detection step in a metadata server to acquire account information, registering reproduction stop position information of the content in the content reproduction step in association with the account information by logging into the metadata server using the account information of the user, and acquiring reproduction stop position information of the content associated with the account information by logging into the metadata server using the account information of the user. In the content reproduction step, the content is reproduced from a beginning position or the acquired reproduction stop position.

In addition, according to still another embodiment of the present disclosure, there is provided a computer program described in a computer-readable form, the computer program causing a computer to function as an account registration unit that registers account information of a user and account information of a group that includes a plurality of users, a metadata retaining unit that retains information of a terminal that the user or the group uses and reproduction stop position information of content in association with the account information of the user or the group, and a metadata providing unit that provides the terminal that the user or the group uses with the reproduction stop position information associated with the account information of the user or the group.

In addition, according to still another embodiment of the present disclosure, there is provided a computer program described in a computer-readable form, the computer program causing a computer to function as a content reproduction unit that reproduces content, a user detection unit that detects a user, a registration unit that registers the user detected by the user detection unit in a metadata server to acquire account information, a reproduction stop position information registration unit that logs into the metadata server using the account information of the user to register reproduction stop position information of the content of the content reproduction unit in association with the account information, and a reproduction stop position information acquisition unit that logs into the metadata server using the account information of the user to acquire the reproduction stop position information of the content associated with the account information. The content reproduction unit reproduces the content from a beginning position or the acquired reproduction stop position.

The embodiments above define computer programs that are each described in a computer-readable form so as to realize predetermined processes on computers. In other words, by installing the computer programs according to the embodiments above in a computer, the same effects as those of the information processing devices according to the embodiments above can be exhibited.

In addition, according to still another embodiment of the present disclosure, there is provided an information communication system including a content server that provides content, a terminal that is used by an individual user or a group that includes a plurality of users to reproduce the content provided by the content server, and a metadata server that retains reproduction stop position information of the user and the group in association with account information, and provides the terminal that the user or the group uses with the reproduction stop position information.

However, the “system” mentioned herein refers to an item obtained by logically assembling a plurality of devices (or functional modules realizing specific functions), regardless of whether such devices or functional modules are provided in a single housing.

According to the embodiment of the present technology disclosed in the present specification, an excellent information processing device and information processing method, computer program, and information communication system that enable a plurality of users and a plurality terminals to properly manage and use reproduction stop position information of content used by a plurality of users at the same time with a simple operation by the users can be provided.

The information communication system to which the present technology disclosed in the present specification is applied is configured such that terminals (shared terminals) used by a plurality of users at the same time are provided with a group account of which the group includes a plurality of users. Such shared terminals can automatically log into a device (metadata server) that retains reproduction stop position information using a group account when activated, and can realize the same use advantage as a terminal (occupied terminal) that is exclusively used by an individual, without paying attention to log-in.

In addition, in the information communication system to which the technology disclosed in the present specification is applied, reproduction stop position information obtained when content reproduction performed in a terminal (shared terminal) used by a plurality of users at the same time is stopped halfway is retained in the device (metadata server) in association with account information of a group that includes the plurality of users, without identifying individual users. Thus, reproduction stop position information retained in association with account information of each user who belongs to the group is not lost. In addition, it is not necessary for the device (metadata server) to manage reproduction stop position information for each account of a user or a group in order to retain reproduction stop position information for the number of terminals within the system.

In addition, according to the embodiment of the technology disclosed in the present specification, since reproduction stop position information of a shared terminal is managed separately from a case in which reproduction of content is stopped in an occupied terminal, a user can start continuous reproduction of content by shifting from an occupied terminal to a shared terminal, or from a shared terminal to an occupied terminal.

In addition, in the information communication system to which the technology disclosed in the present specification is applied, when a shared terminal is controlled by a remote control device (remote controller) that has automatically logged in as an occupied terminal, the shared terminal serves as an occupied terminal of a user by inheriting account information of the user of the occupied terminal and then logging in again. Then, reproduction stop position information associated with the account information of the controlling user can be used, and thereby smooth operability can be obtained. As a shared terminal controlled by an occupied terminal inherits a log-in state of the occupied terminal, reproduction stop position information can be retained and used without causing the user to perform a cumbersome operation.

In addition, according to the embodiment of the technology disclosed in the present specification, since a shared terminal can ascertain the place of origin of corresponding content by acquiring the latest reproduction stop position information thereof after activation, reproduction can be started promptly.

Other objectives, characteristics, and advantages of the technology disclosed in the present specification will be clarified by detailed description based on embodiments described below and accompanying drawings.

### BRIEF DESCRIPTION OF THE DRAWINGS

FIG. 1 is a diagram schematically showing a configuration of an information communication system 100 according to an embodiment of the technology disclosed in the present specification;

FIG. 2 is a diagram showing an example of user account registration of an occupied terminal that one user substantially occupies for use among a plurality of terminals that can be operated within the information communication system 100;

FIG. 3 is a diagram showing an example of user account registration of a shared terminal that may be simultaneously used by a plurality of users among a plurality of terminals that can be operated within the information communication system 100;

FIG. 4 is a diagram showing an example of a communication sequence for performing continuous reproduction of content in the information communication system 100;

FIG. 5 is a diagram showing an example of another communication sequence for performing continuous reproduction of content in the information communication system 100;

FIG. 6 is a diagram showing an example of another communication sequence for performing continuous reproduction of content in the information communication system 100;

FIG. 7A is a diagram showing an example of a communication sequence for performing continuous reproduction of the content in the information communication system 100;

FIG. 7B is a diagram showing an example of a communication sequence for performing continuous reproduction of the content in the information communication system 100;

FIG. 7C is a diagram showing an example of a communication sequence for performing continuous reproduction of the content in the information communication system 100;

FIG. 8 is a diagram showing a configuration example of metadata retained in a metadata server 102;

FIG. 9 is a diagram showing another configuration example of metadata retained in the metadata server 102;

FIG. 10 is a diagram showing a configuration example of a content reproduction screen on which reproduction stop position information for a household and each user is available;

FIG. 11 is a diagram showing an example of a communication sequence for performing continuous reproduction of content in the information communication system 100;

FIG. 12 is a diagram showing the example of communication sequence for performing continuous reproduction of content in the information communication system 100;

FIG. 13 is a diagram schematically showing a functional configuration of an information processing device 1300 that operates as the metadata server 102; and

FIG. 14 is a diagram schematically showing a functional configuration of an information processing device 1400 that operates as occupied terminals 111 and so on or shared terminals 121 and so on.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

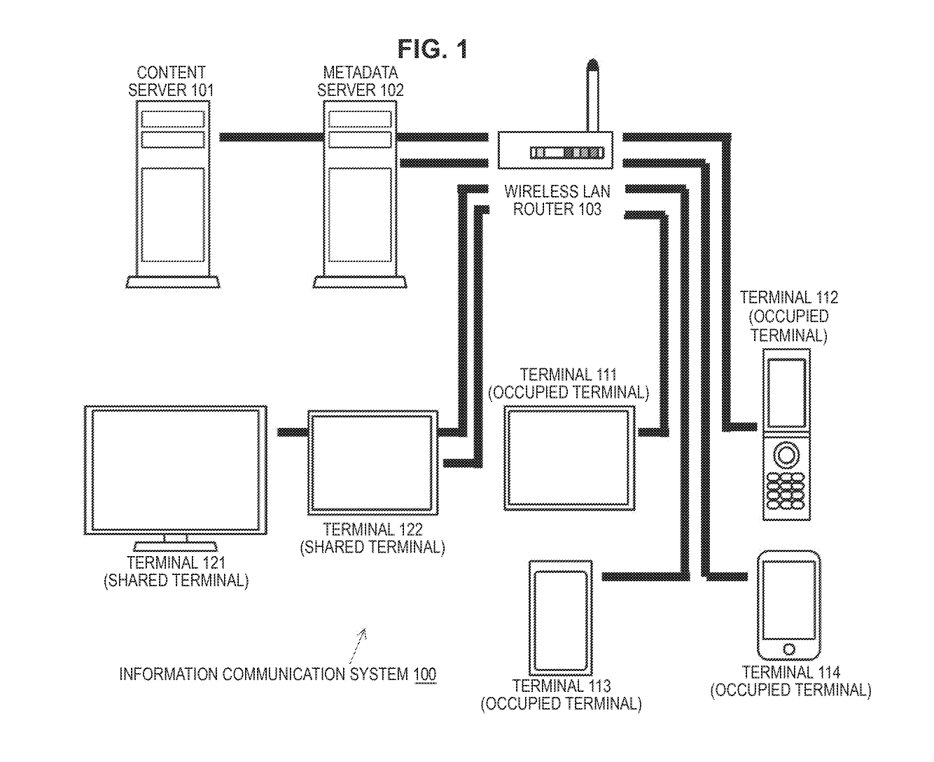

FIG. 1 schematically shows a configuration of an information communication system 100 according to an embodiment of the technology disclosed in the present specification. The information communication system 100 shown in the drawing is configured to include a content server 101 in which content is accumulated, a metadata server 102 that manages metadata relating to reproduction of the content, and a plurality of terminals 111 and so on that reproduce the content, and is assumed to be installed within, for example, a general household.

The content server 101, the metadata server 102, and each of the terminals 111 and so on are connected to a wireless LAN router 103, included in a network. The wireless LAN router 103 has, for example, an access point function. The content server 101 accumulates content such as moving images, music, electronic books, and photos (slide shows) therein, and each of the terminals 111 and so on can reproduce the content. As a reproducing method for content on the terminals 111 and so on, an existing technology such as DLNA (Digital Living Network Alliance) can be used. In addition, each of the terminals 111 and so on performs reproduction of content as a terminal that is simultaneously used by a plurality of users (hereinafter, also referred to as a “shared terminal”), or a terminal that is exclusively used by only one user (hereinafter, also referred to as an “occupied terminal”).

When the terminal 111 reproduces moving image content, for example, the terminal 111 searches for devices on a network based on the DLNA standard to detect the content server 101 that has a content distribution function for reproduction. Then, the terminal 111 acquires information of a list of content kept in the content server 101, or the like using a CDS (Content Directory Service) function provided by the content server 101, and provides a user of the terminal 111 with operability that enables selection of desired content. Then, when the user of the terminal 111 selects desired content, a request for acquiring content is transmitted to the content server 101. The content server 101 transfers content in response to the request. The same applies when content is reproduced in other terminals 112 and so on.

Herein, when a user A was viewing content A using the terminal (occupied terminal) 111, but reproduction of the content is paused for any reason, for example, information on the reproduction stop position is necessary to be stored in order to realize continuous reproduction of content with no omission of the content or overlap in the reproduced range.

Content reproducing devices include those that retain information on reproduction pause positions. Furthermore, there are systems in which information on a reproduction stop position can be shared even with a terminal located in another place when the user A attempts to view the rest of the content using another terminal. However, when one content piece is used by a plurality of users or a plurality of terminals, there is concern that control is complicated, and cumbersome operations are necessary for users.

When a plurality of users A to D view content A at the same time using the terminal (shared terminal) 121 (for example, a large-screen TV), and only the user A leaves but the other users B to D continue the reproduction of the content A, the user A does loses track of how much of the content he or she viewed.

In addition, when the plurality of users A to D stop reproduction of the content A in the terminal (shared terminal 121) at the same time, and then only the user A continuously views the content using the terminal 111 that is his or her occupied terminal using information of the reproduction stop position, there is concern that other users B to D may lose track of how much of the content they viewed, in contrast to the above case.

Thus, the metadata server 102 which includes information on a reproduction stop position of content retained in the content server 101 and keeps metadata used for managing users is installed in the information communication system 100 according to the present embodiment. The metadata server 102 holds reproduction stop position information when a user (including simultaneous use by a plurality of users) stops reproduction of content halfway, and provides reproduction stop position information to terminals (shared terminals or occupied terminals) used in searching when the rest of the content is reproduced. In the example shown in FIG. 1, the metadata server 102 is configured as a physically independent device, but the function of the metadata server may be included in the content server 101, or may be operated as one function (network service) on the Internet.

In order to solve this problem such that a user resumes the reproduction of content from a correct stop position, a mechanism in which reproduction stop position information can be used as supplementary information (metadata) conditioned for users and content between the terminals 111 and so on, on the network is necessary.

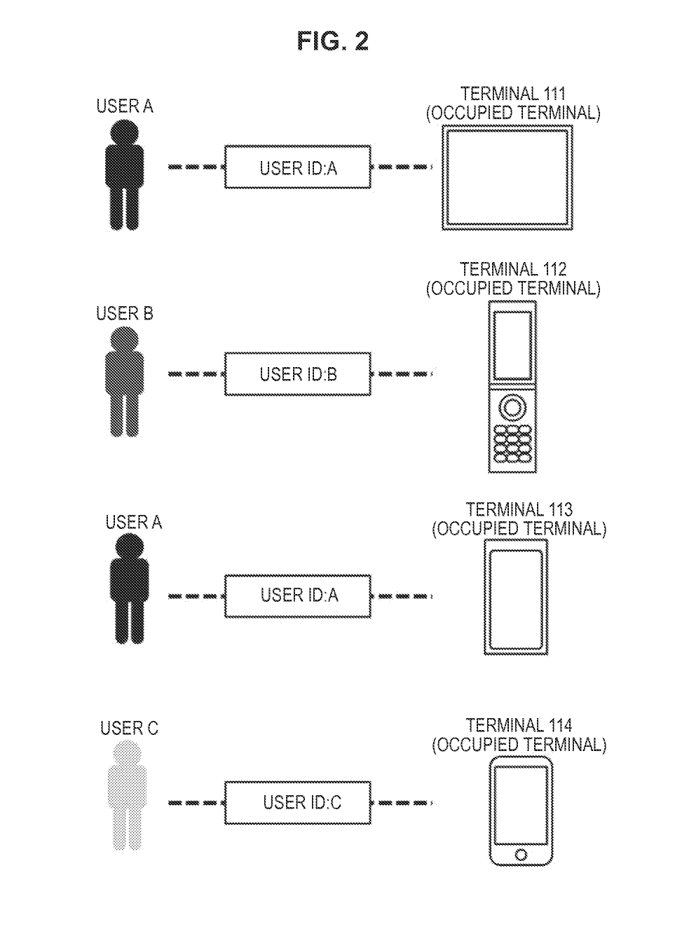

Herein, as shown in FIG. 2, it is assumed that the terminals 111 to 114 out of the plurality of terminals that can be operated within the information communication system 100 are shared terminals that are each occupied and used by one user. In other words, the terminal 111 is occupied by the user A, the terminal 112 is occupied by a user B, the terminal 113 is occupied by the user A, and the terminal 114 is occupied by a user C (it is also assumed that one user uses a plurality of terminals as occupied terminals, and a plurality of users each use one terminal as an occupied terminal). An occupied terminal can substantially uniformly identify a user based on an operation thereof. Thus, when each of the users A and the like first uses the terminals 111 and the like that are occupied terminals, they register user accounts on the metadata server 102. As a result, user IDs are allocated to the users as accounts for logging into the metadata server 102. Then, by the metadata server 102 associating the user IDs with each of the terminals that are occupied terminals (to be described later), when the users start using the occupied terminals, an environment in which the users can be log into and access the metadata server 102 without a log-in operation is provided. In the example shown in FIG. 2, the metadata server 102 designates a user ID:A to the user A, a user ID:B to the user B, and a user ID:C to the user C as accounts for log-in. In addition, the metadata server 102 associates the terminals 111 and 113 with the user ID:A, the terminal 112 with the user ID:B, and the terminal 114 with the user ID:C as occupied terminals. In addition, the metadata server 102 holds reproduction stop position information of content that each of the users viewed in association with the user IDs as metadata of each of the users A to C.

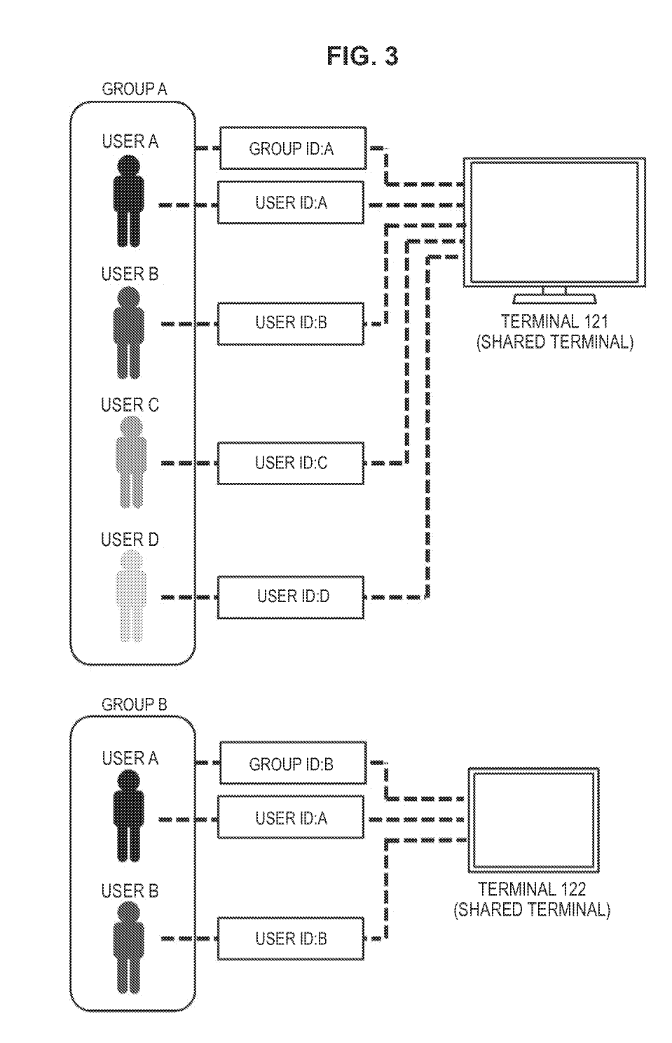

On the other hand, as shown in FIG. 3, the terminals 121 and 122 are each assumed to be shared terminals that are not only occupied by one user but also used by a plurality of users such as in a household at the same time. Also in the terminals of this type, when each of the terminals is occupied by one user, user accounts are registered on the metadata server 102 when the same terminal is first used, as described above. In the example shown in FIG. 3, user IDs are allocated to each of the users A to D of the terminal 121 as accounts for log-in, and user IDs are allocated to each of the users A and B of the terminal 122 as accounts for log-in.

In addition, in response to a case in which each of the terminals 121 and 122 is used at the same time by the plurality of users, the metadata server 102 receives registration of a group including the plurality of users registered in the same terminal, and sets a group ID as an account for group log-in. Then, when any user who is registered in the group starts using the shared terminal, an environment in which the user can be logged into and access the metadata server 102 without a log-in operation is provided by the metadata server 102 associating the group ID with a terminal that is the shared terminal. In the example shown in FIG. 3, the metadata server 102 further receives registration of the users A to D who have been registered as users of the terminal 121, and allocates a group ID:A as an account for logging into the metadata server 102. In the same manner, the metadata server 102 further receives registration of the users A and B who have been registered as users of the terminal 122, and allocates a group ID:B as an account for log-in. In addition, the metadata server 102 associates the terminal 121 with the group ID:A and the terminal 122 with the group ID:B respectively as shared terminals. In addition, the metadata server 102 holds reproduction stop position information of content that each group viewed in association with the group IDs as metadata of each of the groups A and B.

Here, the metadata server 102 limits group registration to a simple function in which a process of including a user who is newly registered in the same group as a user who has already been registered is automatically performed so that only one group uses one terminal when two or more users are registered for one terminal, and the like, and thus users do not have to perform a cumbersome operation. Alternatively, in order to smoothly respond to usage methods of the users assumed thereafter, the users may be caused to select or set whether a user is added to a group that has already been registered, whether another group different from a group registered in a terminal is constituted, or whether a single user who does not belong to any group is registered. To simplify the function, when a user starts using a terminal, it is preferable that the terminal be operated by a user or a group that has already been set without necessitating log-in to the metadata server 102 in any case in which the user is caused to select or set registration as a group. For this reason, a mechanism in which information necessary for log-in is safely held is desirable for each terminal.

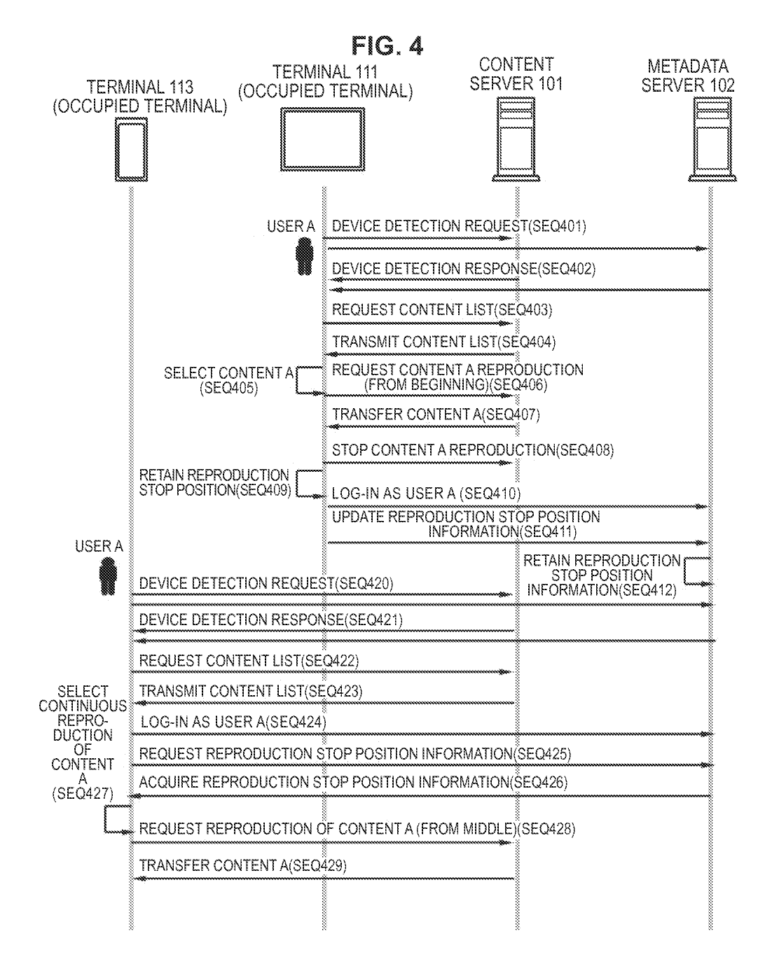

FIG. 4 shows an example of a communication sequence in which users use content in the information communication system 100. In the example shown in the drawing, it is assumed that the user A registers the terminals 111 and 113 as occupied terminals. Then, the user A reproduces moving image content A accumulated in the content server 101 on the terminal 111, pauses the reproduction process, and then resumes the reproduction in the terminal 113. In this case, since the metadata server 102 retains metadata such as a reproduction stop position of the moving image content A, the terminal 113 acquires this reproduction stop position information and continuously reproduces the moving image content A.

When the user A activates the terminal 111, the terminal 111 transmits a device detection request via the wireless LAN router 103 (SEQ401), and searches for a server device on a network. In response, the content server 101 and the metadata server 102 each reply with a device detection response (SEQ402).

After that, the terminal 111 transmits a content list request to the content server 101 (SEQ403). In response, the content server 101 replies with a content list including a content catalog that the server can transmit (SEQ404).

The terminal 111 displays the received content list on a screen. Then, when the user A selects the desired moving image content A from the content list (SEQ405), the terminal 111 transmits a reproduction request (from the beginning of the content) of the moving image content A to the content server 101 (SEQ406). The content server 101 starts transfer of the moving image content A from the beginning in response to this reproduction request (SEQ407).

In order to pause the reproduction of the moving image content A in response to an operation by the user A, or the like, the terminal 111 transmits a request for stopping the content reproduction to the content server 101 (SEQ408). The content server 101 stops the transfer of the moving image content A in response to the reproduction stop request.

The terminal 111 holds the reproduction stop position when the reproduction of the moving image content A is stopped (SEQ409). After that, the terminal 111 logs into the metadata server 102 as the user A (SEQ410), and transmits the reproduction pause position information of the moving image content A to the metadata server 102 (SEQ411). In response, the metadata server 102 holds the received reproduction stop position information of the moving image content A in association with the user ID:A that is account information of the user A (SEQ412).

Then, the user A activates use of the terminal 113 to operate the terminal to continuously reproduce the moving image content A.

When the terminal 113 is started, it transmits a device detection request via the wireless LAN router 103 (SEQ402), and searches for a server device on the network. In response, the content server 101 and the metadata server 102 each reply with a device detection response (SEQ421).

After that, the terminal 113 transmits a content list request to the content server 101 (SEQ422). In response, the content server 101 replies with a content list including a content catalog that the server can transmit (SEQ423).

In addition, the terminal 113 logs into the metadata server 102 as the user A (SEQ424). Then, the terminal 113 requests the reproduction stop position information of the user A (SEQ425). In response, the metadata server 102 replies with the reproduction stop position information in association with the user ID:A (SEQ426).

The terminal 113 displays the content list received in SEQ423 on a screen. In addition, the terminal shows content that is the reproduction stop position information on the content list based on the reproduction stop position information received in SEQ426. This example shown in the drawing shows that the moving image content A on the content list includes the reproduction stop position information of the user A. Then, the user A selects continuous reproduction of the moving image content A from the content list (SEQ427). The terminal 113 transmits a request for reproducing the moving image content A from the reproduction stop position to the content server 101 in response to this selection operation (SEQ428). The content server 101 resumes transfer of the moving image content A from the reproduction stop position in response to the reproduction request (SEQ429). Therefore, the user A can view the rest of the moving image content A on the terminal 113 with no omissions even after the terminal in use is switched from the terminal 111 to the terminal 113.

Note that, even when the moving image content is replaced with content for different types of media such as music, electronic books, or photos (slide shows), the information communication system 100 can manage reproduction stop position information of content in the same manner (the same applies in each communication sequence to be described below).

In the example of the communication sequence shown in FIG. 4, when the user continuously reproduces the rest of the moving image content A in the terminal 113 in another place, he or she operates the reproduction of the moving image content A by operating the terminal 13 (SEQ427). On the other hand, convenience can be further enhanced by adding information that can identify the place of origin of the moving image content A to the reproduction stop position information of the moving image content A transmitted to and retained in the metadata server 102.

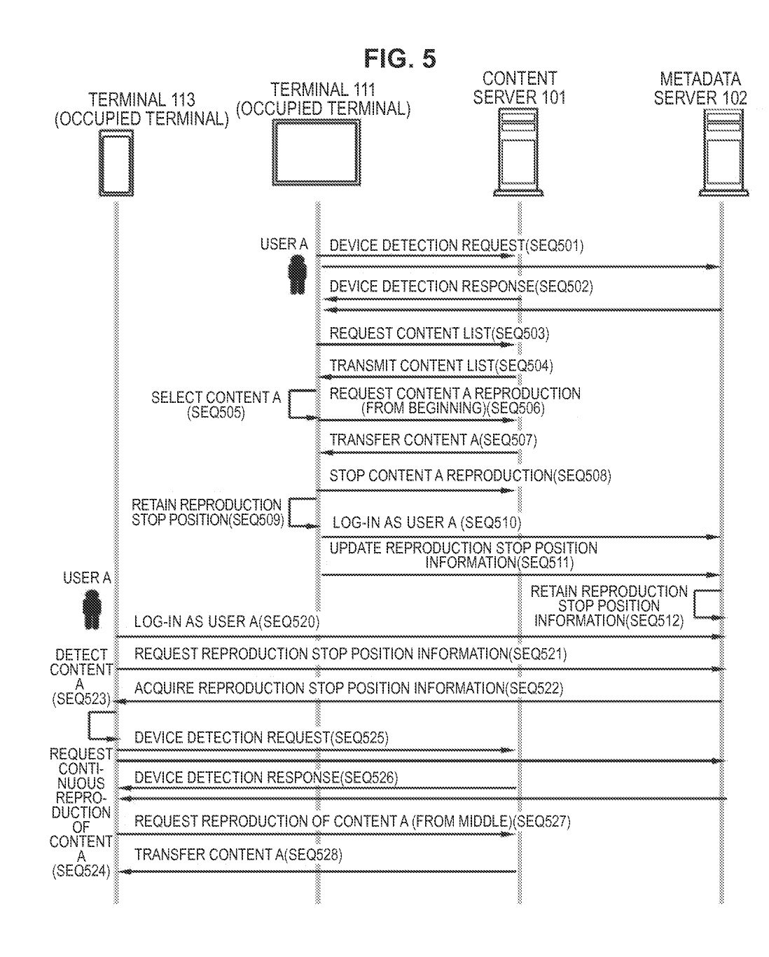

FIG. 5 shows an example of another communication sequence in which the user A continuously reproduces the rest of the moving image content A in another terminal in another place in the information communication system 100. In the example shown in the drawing, convenience can be further enhanced by adding information that can identify the place of origin of the moving image content A to the reproduction stop position information of the moving image content A transmitted to and retained in the metadata server 102

When the user A activates the terminal 111, the terminal 111 transmits a device detection request via the wireless LAN router 103 (SEQ501), and searches for a server device on a network. In response, the content server 101 and the metadata server 102 each reply with a device detection response (SEQ502).

After that, the terminal 111 transmits a content list request to the content server 101 (SEQ503). In response, the content server 101 replies with a content list that includes a content catalog that the server can transmit (SEQ504).

The terminal 111 displays the received content list on a screen. Then, when the user A selects the desired moving image content A from the content list (SEQ505), the terminal 111 transmits a request for reproducing (from the beginning of the content) of the moving image content A to the content server 101 (SEQ506). The content server 101 starts transfer of the moving image content A from the beginning in response to the reproduction request (SEQ507).

The terminal 111 transmits a request for stopping content reproduction to the content server 101 to pause the reproduction of the moving image content A according to an operation of the user A, or the like (SEQ508). The content server 101 stops the transfer of the moving image content A in response to the reproduction stop request.

The terminal 111 retains the reproduction stop position when the reproduction of the moving image content A is stopped (SEQ509). After that, the terminal 111 logs into the metadata server 102 as the user A (SEQ510), and then transmits information on the reproduction stop position of the moving image content A to the metadata server 102 (SEQ511).

The metadata server 102 retains the reproduction stop position information of the moving image content A that has been received from the terminal 111 in association with the user ID:A that is account information of the user A (SEQ512). At this moment, the server further retains information that can identify the place of origin of the moving image content A.

Then, the user A starts the terminal 113 to operate reproduction of the rest of the moving image content A.

The terminal 113 logs into the metadata server 102 as the user A (SEQ520). Then, the terminal 113 request the reproduction stop position information of the user A (SEQ521). In response, the metadata server 102 replies with the reproduction stop position information associated with the user ID:A (SEQ522).

In the example shown in the drawing, the metadata server 102 replies with the reproduction stop position information on the moving image content A of the user A. The terminal 113 detects that the information that can identify the place of origin the moving image content A is added to the received reproduction stop position information (SEQ523). Then, the user A requests continuous reproduction of the moving image content A to the terminal 113 (SEQ524).

The terminal 113 transmits a device detection request via the wireless LAN router 103 (SEQ525), and searches for a server device on the network. In response, the content server 101 and the metadata server 102 each reply with a device detection response (SEQ526).

The terminal 113 transmits a request for reproducing the moving image content A from the reproduction stop position to the content server 101 (SEQ527). The content server 101 resumes transfer of the moving image content A from the reproduction stop position in response to the reproduction request (SEQ528). Thus, even after the user A shifts from the terminal 111 to the terminal 113, he or she can view the rest of the moving image content A with a simple operation.

In the example of the communication sequence shown in FIG. 5, it is preferable that the continuous reproduction request of the moving image content A made by the user A in SEQ524 be simpler than the operation of selecting the moving image content A performed by the user A in SEQ427 in the example of the communication sequence shown in FIG. 4. A method for simplifying the operation will be exemplified below.

When the terminal 113 acquires the reproduction stop position information that can identify the place of origin of the moving content A by automatically issuing SEQ523 after activation, the terminal validates an operator according to the request for starting the continuous reproduction of the same content. The user A starts the continuous reproduction of the moving image content A using the operator.

FIGS. 4 and 5 show the examples of the communication sequences in which continuous reproduction of content is performed when one user A shifts the terminals 111 and 113 which are registered as occupied terminals for his or her use. Next, a communication sequence in which a plurality of users perform continuous reproduction of content that was reproduced on a shared terminal will be described.

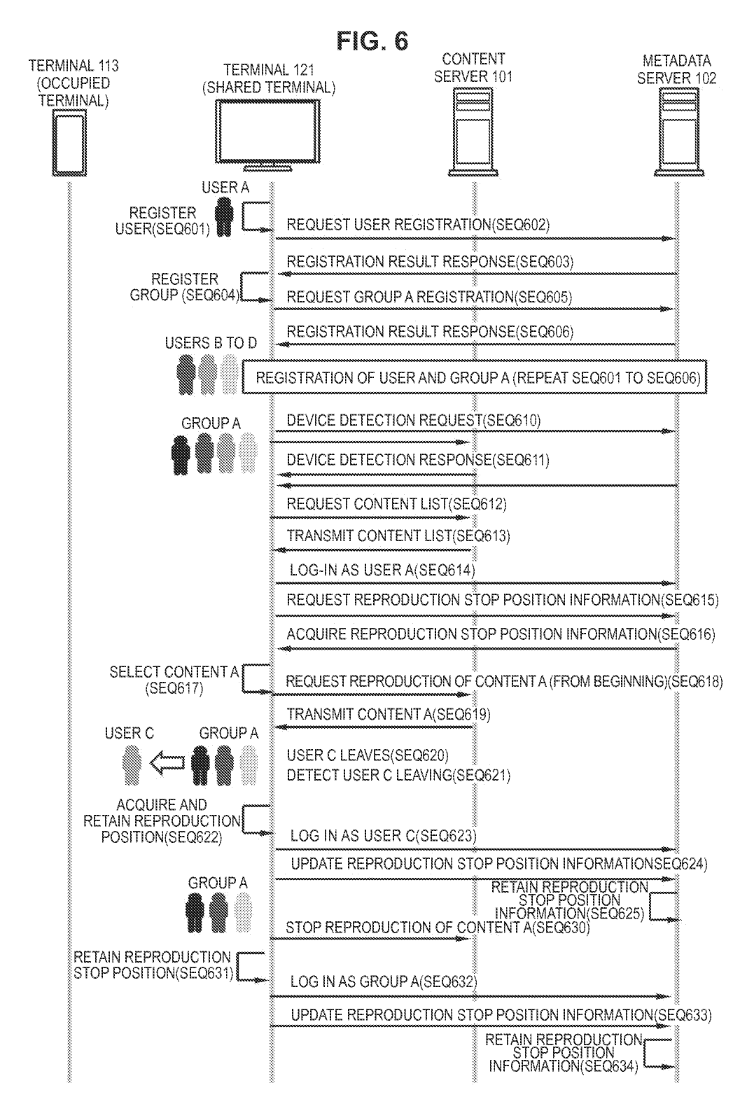

FIG. 6 shows an example of another communication sequence in which a plurality of users use content in the information communication system 100. In the example shown in the drawing, after a group A is constituted by registering a plurality of users who use the terminal 121, the registered users A to D start reproduction of content, the user C leaves the terminal 121 and stops use of the content. In addition, it is assumed that each terminal has a built-in camera, or is provided with a camera linked by external connection, and a user viewing the content A can be determined with this camera using a face recognition function.

First, when the user A starts using the terminal 121 that is a shared terminal, the terminal 121 registers the user A as a user therein (SEQ601), and requests user registration of the user A to the metadata server 102 (SEQ602).

Note that, when the user A is registered in the terminal 121, if the face of the user is photographed using the camera (described above), or information sufficient for identifying an individual extracted from a face image, or face recognition is acquired, the data is retained in the metadata server 102 as individual recognition information associated with a user ID (the same applies to other users B to D).

In response to the user registration request from the terminal 121, the metadata server 102 allocates the user ID:A that is account information to the user A for registration, and replies with a registration result response to the terminal 121 (SEQ603). The metadata server 102 registers the user A in association with his or her individual recognition information with the user ID:A during the registration of the user A.

After that, the terminal 121 performs group registration of the user A therein (SEQ604), and requests registration of the group A including the user A to the metadata server 102 (SEQ605).

The metadata server 102 allocates a group ID:A that is account information to the group A including the user A, and when the group is registered in association with the user ID:A, replies with a registration result response to the terminal 121 (SEQ606).

Then, the users B to D are sequentially added for the user of the terminal 121, the processes of SEQ601 to SEQ606 are repeated for each user so as to perform user registration in the terminal itself and acquisition of account information with respect to the metadata server 102, and additional registration process is performed for the group A with respect to the terminal itself and the metadata server 102.

In addition, although not shown in the drawing, it is assumed that registration of a group B that includes the users A and B is performed in the same manner on the terminal 122 that is another shared terminal.

When the group A that includes the users A to D is constituted as described above, the users A to D view content that is stored on the content server 101 through the terminal 121 as the group A.

At this moment, the terminal 121 first transmits a device detection request via the wireless LAN router 103 (SEQ610) to search for a server device on a network, and then receives a device detection response from the content server 101 and the metadata server 102 (SEQ611).

After that, the terminal 121 transmits a request for a content list to the content server 101 (SEQ612), and then acquires the content list that includes a content catalog that the content server 101 can transmit (SEQ613).

Furthermore, the terminal 121 logs into the metadata server 102 using the group ID:A that is account information of the group A (SEQ614) to request reproduction stop position information (SEQ615). The metadata server 102 replies with reproduction stop position information associated with the group ID:A or reproduction stop position information registered with respect to each of the users A to D in response to the request for the reproduction stop position information from the group A (SEQ616).

The terminal 121 displays the content list received in SEQ613 on a screen. In addition, when the reproduction stop position information of the group A or each of the users A to D is received in SEQ616, the information is shown on the content list. Then, the group A selects the desired moving image content A from the content list (SEQ617). Here, it is assumed that the group A selects reproduction of the moving image content A from the beginning without using the reproduction stop position information. The terminal 121 transmits a request for reproducing the moving image content A (from the beginning) to the content server 101 (SEQ618). The content server 101 starts transfer of the moving image content A from the beginning in response to the reproduction request (SEQ619).

During the reproduction operation of the moving image content A, the terminal 121 monitors each of the users A to D who are viewing the moving image content A using photographed images, and the like from the camera (described above). In the example shown in the drawing, when the user C leaves his or her seat (SEQ620), the terminal 121 detects that the user C has left through camera monitoring (SEQ621).

The terminal 121 determines that the user C who left pauses viewing the moving image content A, and executes a process in which the reproduction position at that time point is updated as reproduction stop position information of the user C who left. In other words, when the terminal 121 acquires the reproduction position at that time point as reproduction stop position information of the user C (SEQ622), the terminal logs into the metadata server 102 as the user C (SEQ623), and then transmits the reproduction stop position information of the moving image content A to the metadata server 102 (SEQ624). With regard to this, the metadata server 102 retains the received reproduction stop position information of the moving image content A in association with the user ID:C that is account information of the user C (or, updates reproduction stop position information associated with the user ID:C) (SEQ625).

Then, the users A, B, and D who are the remaining members of the group A operate the terminal 121 to pause (or stop) the reproduction of the moving image content. In response to this, the terminal 121 requests the content server 101 to stop the reproduction of the moving image content A (SEQ630). In addition, when the terminal 121 retains the reproduction stop position of the group A (SEQ631), the terminal logs into the metadata server 102 as the group A this time (SEQ632), and then transmits the reproduction stop position information of the moving image content A to the metadata server 102 (SEQ633). With regard to this, the metadata server 102 retains the received reproduction stop position information of the moving image content A in association with the group ID:A that is account information of the group A (SEQ634).

When the terminal 121 is equipped with a sensor such as a human-sensing sensor that can detect whether or not a user is in a viewing state without identifying a user, the terminal may stop the reproduction operation of the moving image content A in SEQ630 by detecting that no users are present, and register reproduction stop position information in association with the group ID:A.

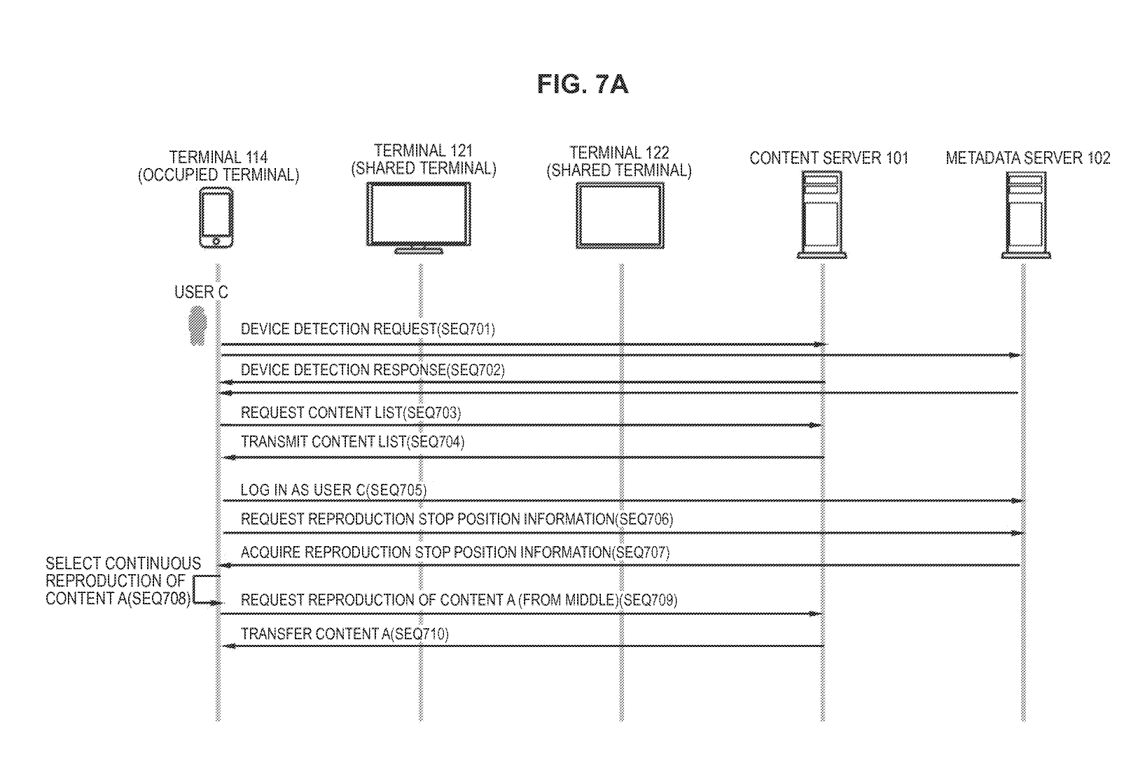

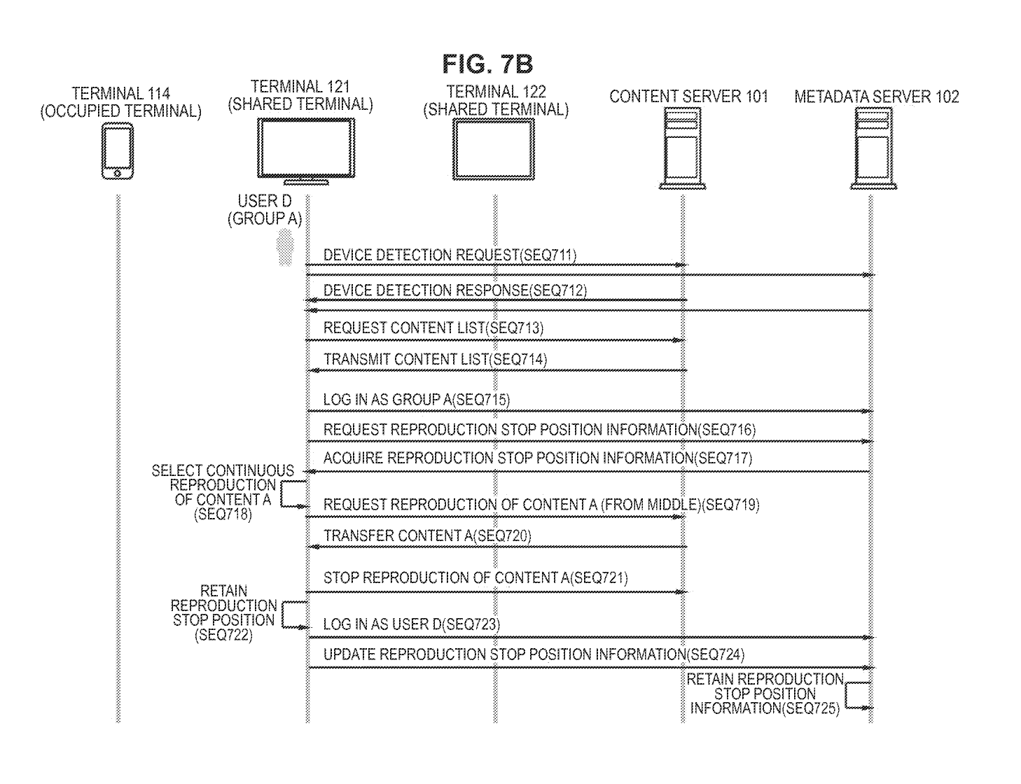

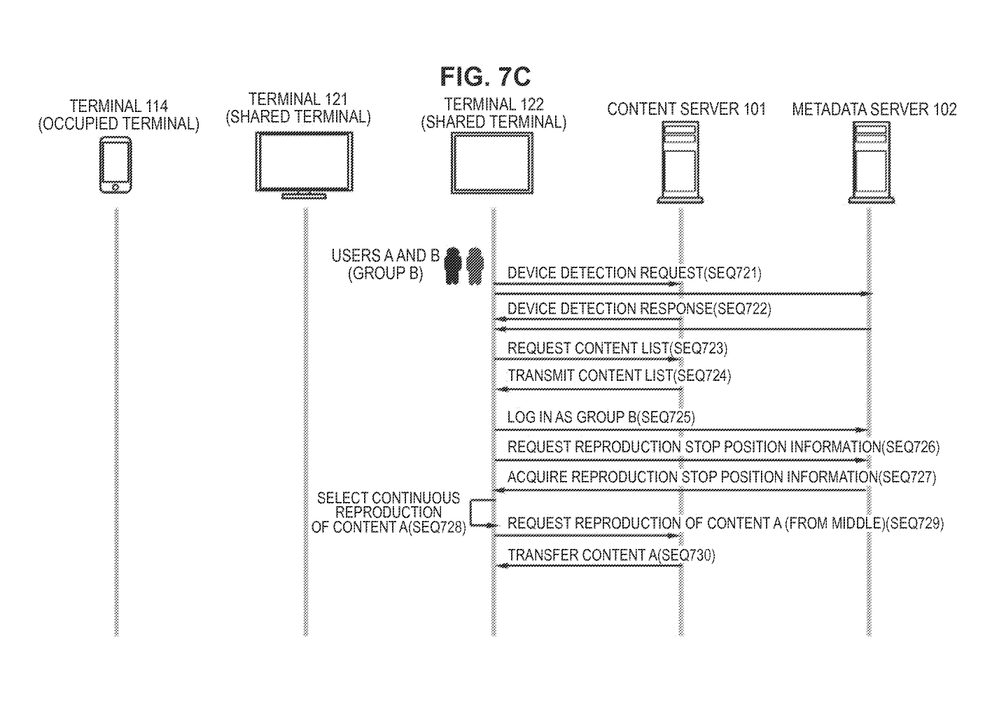

FIGS. 7A to 7C show examples of another communication sequence in which a plurality of users use content in the information communication system 100 in continuation of the communication sequence shown in FIG. 6. In the example shown in FIG. 7A, the user C who left the group A continuously reproduces the moving image content A on his or her occupied terminal. In addition, in the example shown in FIG. 7B, the user D continuously reproduces the moving image content A as the group A on the original shared terminal. In addition, in the example shown in FIG. 7C, the users A and B who are the remaining members of the group A continuously reproduce the moving image content A as a group B that is registered in another shared terminal.

The user C who left the terminal 121 (group A) in SEQ620 then operates the terminal 114 that is his or her own occupied terminal so as to reproduce the rest of the moving image content A.

When the user C activates the terminal 114, the terminal 114 transmits a device detection request via the wireless LAN router 103 (SEQ701) to search for a server device on a network. In response, the content server 101 and the metadata server 102 each reply with a device detection response (SEQ702).

After that, the terminal 114 transmits a request for a content list to the content server 101 (SEQ703). In response, the content server 101 replies with the content list that includes a content catalog that the same server can transmit (SEQ704).

Then, the terminal 114 logs into the metadata server 102 as the user C (SEQ705). Then, the terminal 114 requests the reproduction stop position information of the user C from the metadata server 102 (SEQ706). In response, the metadata server 102 replies with the reproduction stop position information associated with the user ID:C (SEQ707).

The terminal 114 displays the content list received in SEQ704 on a screen. In addition, the content that is reproduction stop position information is shown on the content list based on the reproduction stop position information received in SEQ707. The example shown in the drawing shows that the reproduction stop position information of the user C is included in the moving image content A on the content list. Then, the user C selects continuous reproduction of the moving image content A from the content list (SEQ708). The terminal 114 transmits a request for reproducing the moving image content A from the reproduction stop position to the content server 101 in response to the selection operation (SEQ709). The content server 101 starts transfer of the moving image content A from the reproduction stop position thereof in response to the reproduction request (SEQ710). Accordingly, the user C can view the rest of the moving image content A on the terminal 114 with no omissions even after shifting from the terminal 121 to the terminal 114. In addition, when the reproduction of the moving image content A is stopped, the terminal 114 transmits reproduction stop position information at that time to the metadata server 102, and the reproduction stop position information associated with the user ID:C is updated on the metadata server 102 side (not shown in the drawing).

Meanwhile, the user D who is one of the members of the group A then starts use of the original terminal 121 to operate the terminal to reproduce the rest of the moving image content A as the group A.

When the user D activates the terminal 121, the terminal 121 transmits a device detection request via the wireless LAN router 103 (SEQ711) to search for a server device on the network. In response, the content server 101 and the metadata server 102 each reply with a device detection response (SEQ712).

After that, the terminal 121 transmits a request for a content list to the content server 101 (SEQ713). In response, the content server 101 replies with the content list that includes a content catalog that the same server can transmit (SEQ714).

Then, the terminal 121 logs into the metadata server 102 as the group A (SEQ715). Then, the terminal 121 request the reproduction stop position information of the group A from the metadata server 102 (SEQ716). In response, the metadata server 102 replies with the reproduction stop position information of the moving image content A associated with the group ID:A (SEQ717).

The terminal 121 displays the content list received in SEQ714 on a screen. In addition, the content that is reproduction stop position information is shown on the content list based on the reproduction stop position information received in SEQ717. The example shown in the drawing shows that the reproduction stop position information of the group A is included in the moving image content A on the content list. Then, the user D selects continuous reproduction of the moving image content A from the content list (SEQ718). The terminal 121 transmits a request for reproducing the moving image content A from the reproduction stop position to the content server 101 in response to the selection operation (SEQ719). The content server 101 resumes transfer of the moving image content A from the reproduction stop position thereof in response to the reproduction request (SEQ720). Accordingly, the user D can view the rest of the moving image content A on the original terminal 121 as the group A with no omissions.

After that, the terminal 121 transmits a request for stopping the content reproduction to the content server 101 in order to pause the reproduction of the moving image content A according to an operation of the user D, or the like (SEQ721). The content server 101 stops the transfer of the moving image content A in response to the reproduction stop request.

The terminal 121 retains the reproduction stop position when the reproduction of the moving image content A is stopped (SEQ722). After that, when the terminal 121 logs into the metadata server 102 again as the user D (SEQ723), the terminal transmits the reproduction stop position information of the moving image content A to the metadata server 102 (SEQ724). In response, the metadata server 102 retains the received reproduction stop position information of the moving image content A in association with the user ID:D that is account information of the user D (SEQ725). In short, FIG. 7B shows an example of a communication sequence in which the user D exclusively uses the terminal 121 that is a shared terminal using his or her personal user ID:D. It will be sufficiently understood that, when a user logs into a shared terminal with his or her personal account information, the user can acquire reproduction stop position information of a group to which he or she belongs.

In addition, both users A and B who are other members of the group A move together to another place for the terminal 122 of the group B, and operate the terminal to reproduce the rest of the moving image content A as the group B.

When the users A and B activate the terminal 122, the terminal 122 transmits a device detection request via the wireless LAN router 103 (SEQ721) to search for a server device on the network. In response, the content server 101 and the metadata server 102 each reply with a device detection response (SEQ722).

After that, the terminal 122 transmits a request for a content list to the content server 101 (SEQ723). In response, the content server 101 replies with the content list that includes a content catalog that the same server can transmit (SEQ724).

Then, the terminal 122 logs into the metadata server 102 as the group B (SEQ725). The terminal requests reproduction stop position information associated with the group ID:B (SEQ726). Then, the terminal 122 requests the reproduction stop position information described in paragraph [0109] and the following paragraphs of the present specification from the metadata server 102 (SEQ726). In response, the metadata server 102 replies with the reproduction stop position information of the moving image content A according to the request (SEQ727).

The terminal 122 displays the content list received in SEQ724 on a screen. In addition, the terminal shows content that is reproduction stop position information on the content list based on the reproduction stop position information received in SEQ727. The example shown in the drawing shows that the reproduction stop position information is included in the moving image content A on the content list. Then, the users A and B select continuous reproduction of the moving image content A from the content list as the group B (SEQ728). The terminal 122 transmits a request for reproduction of the moving image content A from the reproduction stop position thereof to the content server 101 in response to the selection operation (SEQ729). The content server 101 resumes transfer of the moving image content A from the reproduction stop position in response to the reproduction request (SEQ730). Accordingly, the users A and B can view the rest of the moving image content A as the group B with no omissions even after shifting from the terminal 121 to the terminal 122. In addition, when the reproduction of the moving image content A is stopped, the terminal 122 transmits reproduction stop position information at that time to the metadata server 102, and reproduction stop position information associated with the group ID:B is updated on the metadata server 102 side (not shown in the drawing).

Herein, metadata that is generated and retained in the metadata server 102 will be described.

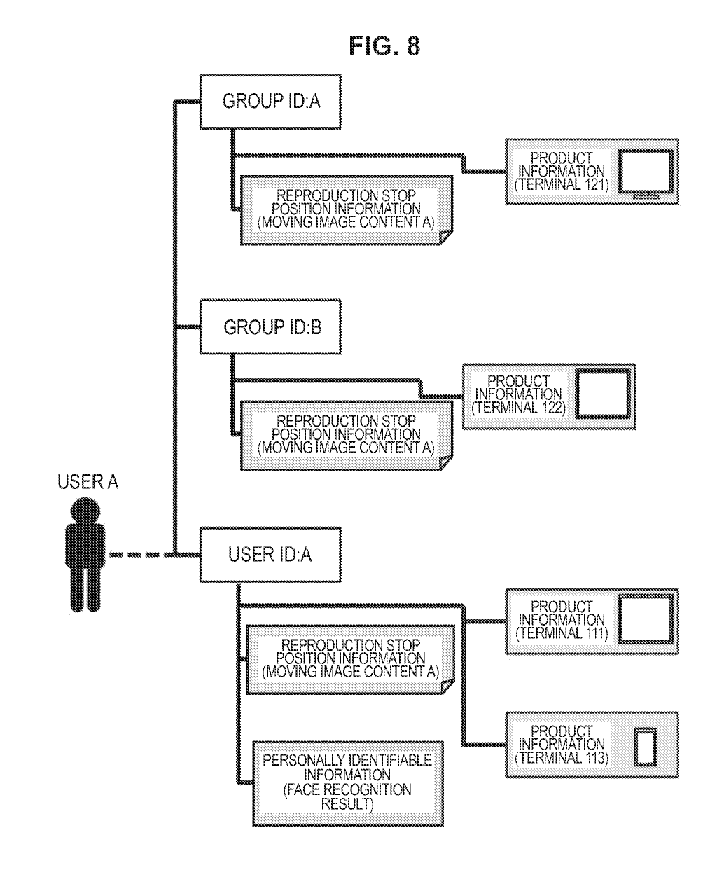

FIG. 8 shows a configuration example of metadata retained in the metadata server 102. The drawing illustrates metadata relating to the user A.

The user A has the user ID:A as an account for log-in to the metadata server 102. In the metadata server 102, reproduction stop position information for each piece of content that the user A views, personally identifiable information of the user A, and product information of respective terminals 111 and 113 that the user A uses as occupied terminals is registered in association with the user ID:A. Personally identifiable information referred to herein is, for example, a face image obtained by photographing the user A using a camera (as described above) or a face recognition result, or information read from an IC card that the user A possesses.

In addition, since the user A is a user of the terminal 121 and the terminal 122 that are shared terminals, and a member of the group A and the group B registered on each of the shared terminals, the group ID:A that is an account for log-in as the group A and the group ID:B that is an account for log-in as the group B are registered in association with the user ID:A. Furthermore, product information of the terminal 121 that the group A uses and reproduction stop position information for each content piece that the group A uses are registered in association with the group ID:A. In the same manner, product information of the terminal 122 that the group B uses and reproduction stop position information for each content piece that the group B uses are registered in association with the group ID:A.

By associating the product information of the terminals 111 and 113 with the user ID:A, when the user A starts using the terminals 111 and 113 that are his or her occupied terminals, an environment in which the user A can be logged into and access the metadata server 102 without his or her log-in operation is provided. In addition, by associating the product information of the terminal 121 with the group ID:A, and associating the product information of the terminal 122 with the group ID:B, when the user A starts using the terminals 121 and 122 that are shared terminals of the groups A and B, respectively, the user A (or another member of the groups A and B) can be logged into and access the metadata server 102 as the groups A and B without his or her log-in operation.

In addition, reproduction stop position information associated with the group ID:A can be acquired when the user A logs into the metadata server 102 using the associated terminal 121 as a shared terminal, and every time the reproduction of the content is stopped, the reproduction stop position information of the group ID:A is updated. In the same manner, reproduction stop position information associated with the group ID:B can be acquired when the user A logs into the metadata server 102 using the associated terminal 122 as a shared terminal, and every time the content is reproduced and the reproduction is stopped, the reproduction stop position information is updated.

On the other hand, the reproduction stop position information associated with the user ID:A can be acquired when the metadata server 102 with the user ID:A is logged into using either of the associated terminal 111 or 113 as an occupied terminal, or the metadata server 102 is logged into with the group ID associated with the user ID:A using either of the associated terminal 121 or 122 as a shared terminal, and every time the content is reproduced and the reproduction is stopped, the reproduction stop position information is updated. In addition, when the metadata server 102 is logged into with the user ID:A by using automatic log-in of the terminal 111 or 113 that is an occupied terminal of the user A, reproduction stop position information associated with each of the groups A and B to which the user A belongs, in other words, the group ID:A and the group ID:B, can also be acquired.

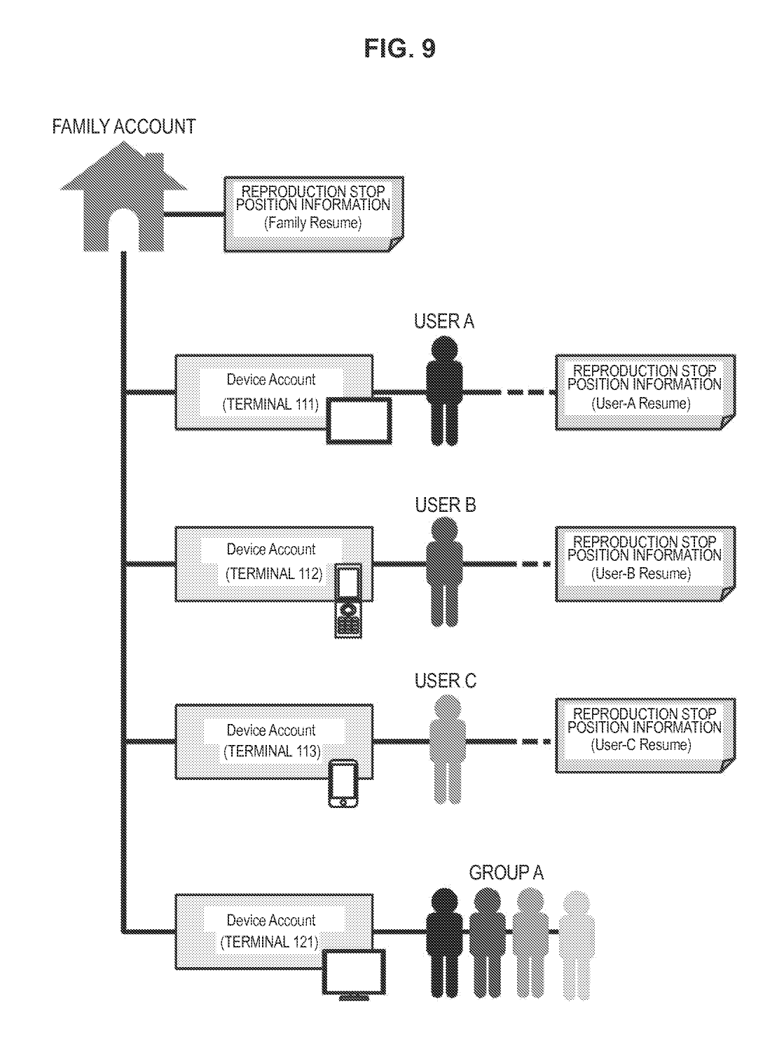

FIG. 9 shows another configuration example of metadata retained in the metadata server 102. The example shown in the drawing assumes that a network constructed with the wireless LAN router 103 is a home network, and users present in the information communication system 100 belong to a family.

The family has a family account (Family Account) as an account for log-in that enables log-in and access to the metadata server 102 as a family, and the family account is associated with reproduction stop position information for each piece of content that the family views (Family Resume).

The family account is associated with respective terminals that are installed within the household and connected to the wireless LAN router 103. The terminals are broadly divided into shared terminals that a plurality of users in the household use at the same time and occupied terminals which are assumed to be almost exclusively used by one user and not assumed to be used by a plurality of users at the same time. For each of the terminals, an account for log-in (Device Account) is set.

Each account for log-in of a user (User Account) is associated with the occupied terminals. In addition, reproduction stop position information (Use Resume) for each piece of content that a user views is associated with the user. On the other hand, a plurality of users who use the shared terminals at the same time are associated therewith. Reproduction stop position information of the shared terminals is reproduction stop position information of the family (Family Resume).

The occupied terminals automatically log into the metadata server 102 with the associated personal account for log-in (User Account) of a user, and update reproduction stop position information of the user. On the other hand, the shared terminals automatically log into the metadata server 102 with an account for terminals (Device Account), and update reproduction stop position information for the family (Family Resume).

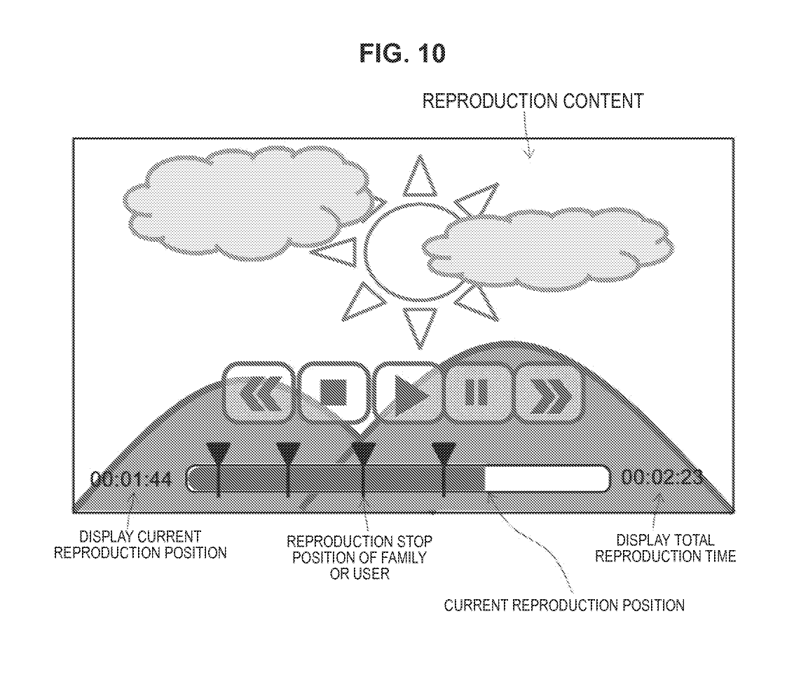

According to the metadata configuration shown in FIG. 9, sharing of reproduction stop position information among the plurality of users in the family can be realized. Each device of the occupied terminals and shared terminals can be used in continuous reproduction of content referring to reproduction stop position information for the family and each user. In addition, when content is reproduced on a shared terminal for a group, reproduction stop position information of each user within the group can also be shared in addition to reproduction stop position information of the group. FIG. 10 shows a configuration example of a content reproduction screen on which reproduction stop position information for a family and each user is available. The reproduction screen displays buttons for instructing rewinding, reproduction stop, pause, fast forward of content and a horizontal bar that indicates a current reproduction position. A value of total reproduction time of content is shown at the right end of the horizontal bar, and the time of a current reproduction position is displayed at the left end thereof. In addition, anchors (▾) indicating reproduction stop positions for a family and each user are respectively placed on corresponding positions of the horizontal bar.

In the example of the communication sequence shown in FIGS. 6 and 7, users and groups are registered in advance in the terminals 121 and 122 which are shared terminals. In addition, when a use state of a terminal is detected according to the function of detection mechanism such as a built-in camera, or a human-sensing sensor, and there are a plurality or an unidentified number users, the metadata server 102 is set to be logged into with a group ID (for example, SEQ614, SEQ630, and SEQ725). When a shared terminal does not include user detection mechanism, if the metadata server 102 is set in advance to be logged into with either a user or group account upon start of using the terminal, the user may not perform a cumbersome log-in operation.

On the other hand, there are many cases in which multifunctional terminals such as smartphones that have been widely proliferated in recent years provide an application that controls AV devices with a remote control operation, or the like. When it is applied to the information communication system 100 according to the present embodiment, it is assumed that an application to control another device is installed in an occupied terminal that is exclusively used by a user, so as to operate another occupied or shared terminal in which the same user is registered by remote controlling. For example, a shared terminal that is controlled with a remote control operation, or the like by an occupied terminal of a user can also detect a personal usage state of the user, not a usage state of a group to which the user belongs.

In the example of the communication sequence shown in FIGS. 6 and 7, the shared terminals are assumed to be used by a group, and the metadata server 102 is assumed to be logged into and accessed with the associated groups ID. However, when a shared terminal is controlled by an occupied terminal of a user by a remote control operation, even if the shared terminal is associated with a plurality of user IDs, the shared terminal can determine personal use by a user instead of use by a group. Thus, when a terminal is controlled by an occupied terminal, even if it is a shared terminal, more favorable use conditions can be achieved by logging into and accessing the metadata server 102 with a corresponding user ID.

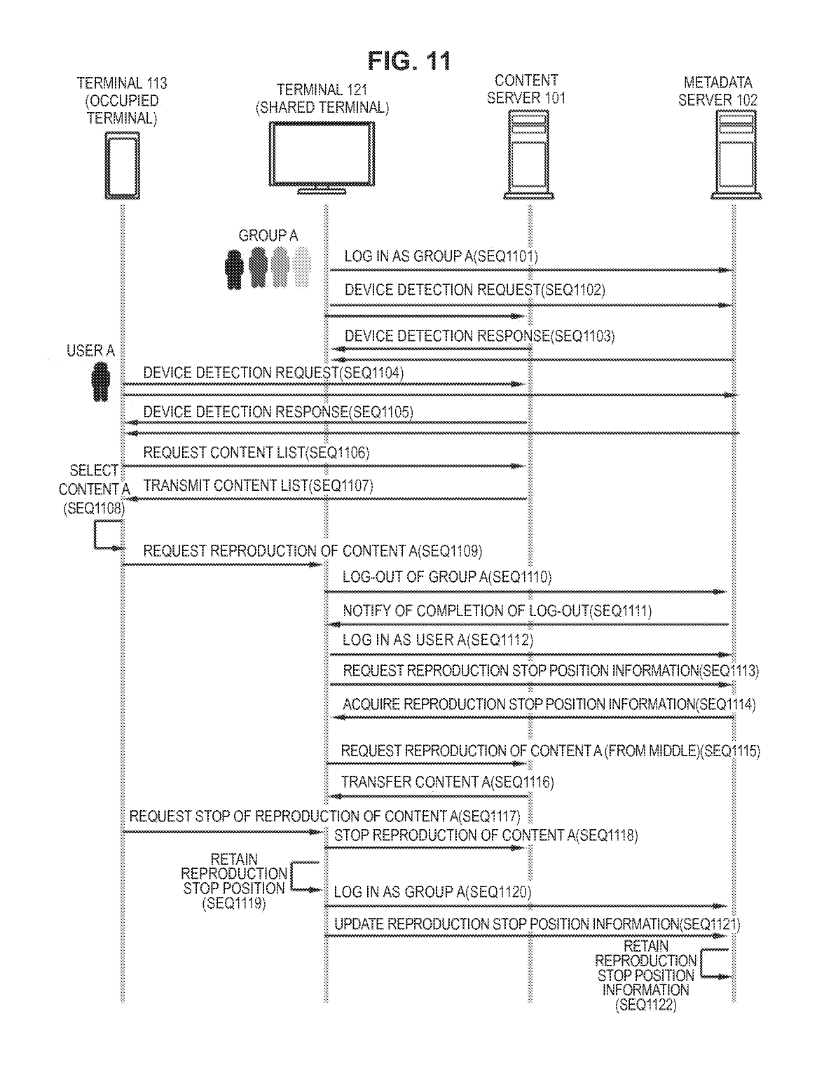

FIG. 11 shows an example of a communication sequence in which a user controls a shared terminal with his or her occupied terminal to use content in the information communication system 100. In the example shown in the drawing, the user A controls the terminal 121 that is a shared terminal of the group A to which the user A belongs using a remote controlling function of the terminal 113 that is his or her occupied terminal so as to perform continuous reproduction of the moving image content A. When controlled by the occupied terminal of the user A, the terminal 121 determines the control to be use by the user A, not by the group A, and performs continuous reproduction using reproduction stop position information associated with the user A.

As the group A that includes the users A to D starts using the terminal 121, the terminal 121 logs into the metadata server 102 as the group A (SEQ1101). Then, the terminal 121 transmits a device detection request via the wireless LAN router 103 (SEQ1102) to search for a server device on a network, and then receives device detection responses from the content server 101 and the metadata server 102 (SEQ 1103).

On the other hand, the user A attempts to perform a remote control operation on the terminal 121 using the terminal 113 that is his or her occupied terminal.

As the user A starts using the terminal 113, the terminal 113 transmits a device detection request via the wireless LAN router 103 (SEQ1104) to search for a server device on the network. In response, the content server 101 and the metadata server 102 each reply with a device detection response (SEQ1105).

After that, the terminal 113 transmits a request for a content list to the content server 101 (SEQ1106). In response, the content server 101 replies with the content list that includes a content catalog that the server can transmit (SEQ1107).

The terminal 113 displays the received content list on a screen. Then, when the user A selects desired moving image content A from the content list (SEQ1108), the terminal 113 transmits a request for reproduction of the moving image content A to the terminal 121 (SEQ1109). This content reproduction request includes information for identifying the selected moving image content A and the user ID:A that is account information of the user A.

Although the terminal 121 was in use under operation as a shared terminal of the group A, it is switched to be in a personal use by the user A as the terminal receives the content reproduction request for the moving image content A from the terminal 113. To be specific, the terminal 121 logs out from the metadata server 102 to which the terminal logged in as the group A (SEQ1110), and when the terminal is informed of completion of log-out from the metadata server 102 (SEQ1111), it logs in again to the metadata server 102 as the user A using the user ID:A that is included in the content reproduction request (SEQ1112).

Next, the terminal 121 requests reproduction stop position information of the user A from the metadata server 102 (SEQ1113). In response, the metadata server 102 replies with reproduction stop position information associated with the user ID:A (SEQ1114). Then, when the terminal 121 can receive the reproduction stop position information of the moving image content A for which the reproduction has been requested, the terminal transmits a request for reproduction of the moving image content A from the reproduction stop position thereof to the content server 101 (SEQ1115). The content server 101 starts transfer of the moving image content A from the reproduction stop position thereof in response to the reproduction request (SEQ1116), and reproduction of the moving image content A is started from the reproduction stop position on the terminal 121. Accordingly, while performing a remote control operation on the terminal 121 using the terminal 113, the user A can view the rest of the moving image content A on the terminal 121 with no omissions.

After that, the terminal 113 transmits a reproduction stop request of the moving image content A to the terminal 121 (SEQ1117). This content reproduction stop request includes information for identifying the selected moving image content A and the user ID:A that is the account information of the user A.

In response to the content reproduction stop request from the terminal 1113, the terminal 121 requests the content server 101 to stop the reproduction of the moving image content A (SEQ1118), and at the same time retains the reproduction stop position of the user A (SEQ1119). Then, the terminal 121 logs into the metadata server 102 as the user A using the user ID:A that is included in the content reproduction stop request (SEQ1120), and then transmits reproduction stop position information of the moving image content A to the metadata server 102 (SEQ1121). With regard to this, the metadata server 102 retains the received reproduction stop position information of the moving image content A in association with the user ID:A that is the account information of the user A (SEQ1122). Therefore, when viewing of the moving image content A is later resumed with the terminals 111 and 113 which are the user's occupied terminals and when viewing of the moving image content A is resumed by operating shared terminals such as the terminals 121 and 122 with the terminals 111 and 113 in a remotely controlling manner, the user A can continuously reproduce the content with no omissions.

When a shared terminal is controlled by a device that is not capable of identifying a user, such as a general remote controlling device of an infrared communication type accompanied by an AV device, the shared terminal determines the control to be use by an unidentified user, and then logs into the metadata server 102 with a group ID that has already been registered. On the other hand, when a shared terminal is controlled by an occupied terminal such as the terminal 113, since the shared terminal determines the control to be personal use by the user A that has been registered in the terminal 113, continuous reproduction of content can be performed for an occupied terminal of the user A.

In the examples of the communication sequences described above, the metadata server 102 retains reproduction stop position information in association with account information (a user ID or a group ID) of a user or a group that is logging in when the reproduction of the content in a terminal is stopped. Continuous reproduction of content can be realized with a simpler operation in such a way that specifiable information including the place of origin of content is retained in a format that is associated with or implies reproduction stop position information.

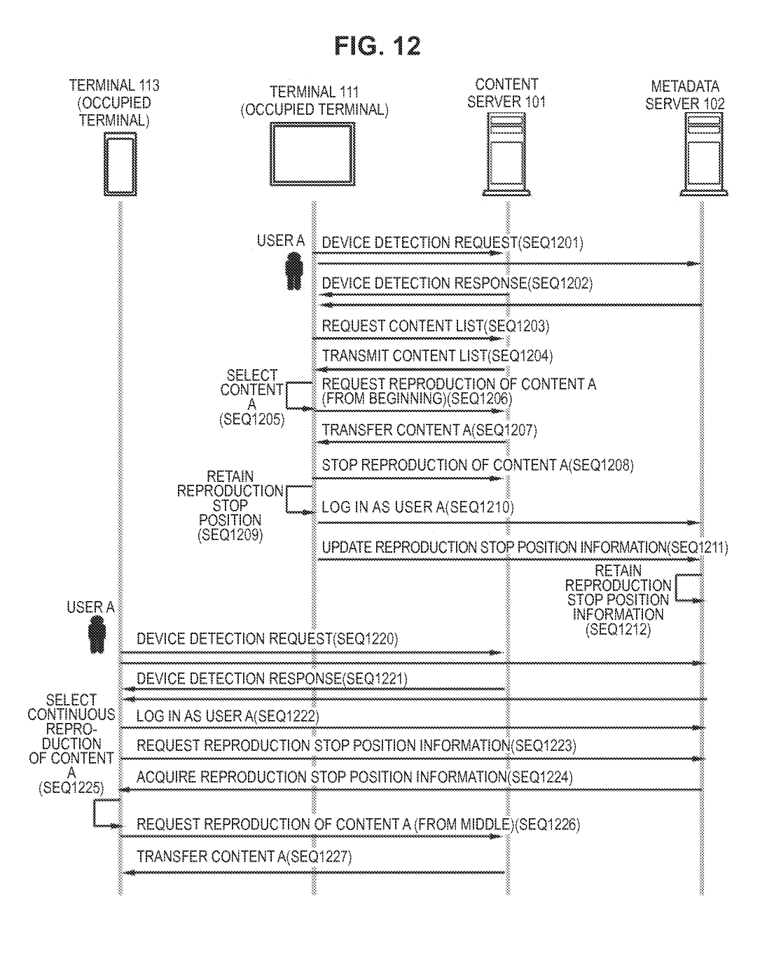

FIG. 12 shows an example of a communication sequence in which the user A reproduces the rest of the moving image content A with a terminal in another place in the information communication system 100. In the example shown in the drawing, information that can identify the place of origin of the moving image content A is retained in a format that is associated with or implies reproduction stop position information of the moving image content A received and retained by the metadata server 102, and convenience is thereby further enhanced.

When the user A activates the terminal 111, the terminal 111 transmits a device detection request via the wireless LAN router 103 (SEQ1201) to search for a server device on the network. In response, the content server 101 and the metadata server 102 each reply with a device detection response (SEQ1202).

After that, the terminal 111 transmits a request for a content list to the content server 101 (SEQ1203). In response, the content server 101 replies with the content list that includes a content catalog that the server can transmit (SEQ1204).

The terminal 111 displays the received content list on a screen. Then, when the user A selects the desired moving image content A from the content list (SEQ1205), the terminal 111 transmits a request for reproducing the moving image content A (from the beginning of the content) to the content server 101 (SEQ1206). In response to the reproduction request, the content server 101 starts transfer of the moving image content A from the beginning (SEQ1207).

The terminal 111 transmits a request for stopping the reproduction of the content to the content server 101 in order to pause the reproduction of the moving image content A according to an operation of the user A, or the like (SEQ1208). The content server 101 stops transfer of the moving image content A in response to the reproduction stop request.

The terminal 111 retains the reproduction stop position when the reproduction of the moving image content A is stopped (SEQ1209). After that, the terminal 111 logs into the metadata server 102 as the user A (SEQ1201), and then transmits reproduction stop position information of the moving image content A to the metadata server 102 (SEQ1211). In response, the metadata server 102 retains the received reproduction stop position information of the moving image content A in association with the user ID:A that is the account information of the user A (SEQ1212). At this moment, the server further retains information that can identify the place of origin of the moving image content A in a format that is associated with or implies the reproduction stop position information.

After that, the user A starts the use of the terminal 113 to operate the reproduction of the rest of the moving image content A.

When activated, the terminal 113 transmits a device detection request via the wireless LAN router 103 (SEQ1220) to search for a server device on the network. In response, the content server 101 and the metadata server 102 each reply with a device detection response (SEQ1221).

After that, the terminal 113 logs into the metadata server 102 as the user A (SEQ1222), and then requests the reproduction stop position information of the user A (SEQ1223). In response, the metadata server 102 replies with the reproduction stop position information of the moving image content A associated with the user ID:A (SEQ1124).

Upon receiving the reproduction stop position information of the moving image content A, the terminal 113 displays that there is content that can be continuously reproduced to the user A using a screen display, or the like to promote a start of reproduction. Here, when the user A allows continuous reproduction of the moving image content A (SEQ1225), the terminal 121 checks the place of origin of the moving image content A included in the reproduction stop position information, and then identifies the content server 101. Then, the terminal 121 transmits a request for reproducing the moving image content A (from the reproduction stop position) to the content server 101 (SEQ1226). The content server 101 resumes transfer of the moving image content A from the reproduction stop position in response to the reproduction request (SEQ1227). Accordingly, the user can view the rest of the moving image content A with no omissions through a simple operation even after shifting from the terminal 111 to the terminal 113.

The information communication system 100 shown in FIG. 1 is a system in which user authentication (log-in of a user or a group to the metadata server 102) is performed using the terminals 111 and so on. When both of information of a user who is using a terminal and information of the terminal in use have not been registered in the metadata server 102, a user ID can be acquired as an account for log-in by registering the user in the metadata server 102. In addition, when a terminal to be used can obtain personally identifiable information with which an individual can be identified by photographing his or her face using a built-in camera thereof, the metadata server 102 can retain the personally identifiable information in association with account information.

In addition, when information of a user who is using a terminal is not registered, but information of another user is registered in the terminal in use, a new user can be registered in the metadata server 102 as a group that shares the terminal with the registered user, and a group ID can thereby be acquired as an account for log-in. A new user may be automatically registered as a group, or may be allowed to select whether or not to share the terminal with the registered user. In addition, when sharing is not selected, the information of the registered user in the metadata server 102 may be deleted, the information of the new user may be overwritten, or the information of the new user may be additionally registered alongside the information of the registered user.

When the user chooses not to share the terminal with the registered user but to additionally register his or her information, a setting to enable automatic authentication (automatic log-in with the user ID) upon the start of terminal use is possible. In addition, in the latter case, when personally identifiable information can be obtained by photographing the face of the user with a built-in camera of the terminal, or the like, the setting to enable automatic authentication (automatic log-in with the user ID) upon the start of terminal use is possible.

In addition, when a user who is newly registered in a terminal chooses to share the terminal with a registered user (in other words, when group registration is performed), the terminal checks the metadata server 102 for whether or not there is a group that includes the registered user. Then, when there is a registered group, the terminal registers the user in the metadata server 102 as a new user of the group. On the other hand, when there is no registered group, the terminal generates a group that includes the registered user and a newly-registered user so as to be registered in the metadata server 102.

In both cases, during and after the group registration process in the terminal, a setting to enable automatic authentication (in other words, automatic log-in to the metadata server 102 with the group ID) upon the start of terminal use is possible. Alternatively, by cancelling automatic group authentication upon the start of terminal use, log-in with a user ID is also possible.

When automatic group authentication is cancelled, a setting to enable automatic authentication (automatic log-in with the user ID) is possible. In addition, when personally identifiable information can be obtained by photographing the face of the user using the built-in camera of the terminal, or the like, the setting to enable automatic authentication (automatic log-in with the user ID) upon the start of terminal use is possible.

In addition, when a user who will be newly registered in a terminal selects group registration so as to be registered in an existing group or in a new group, if personally identifiable information can be obtained by photographing the face of the user with a built-in camera of the terminal and at least one user belonging to the group is detected when use of the terminal is started, a setting to enable automatic authentication (in other words, automatic log-in to the metadata server 102 with a group ID) is possible.

When a user whose user ID is already registered in the metadata server 102 starts the use of a terminal that is not registered as his or her terminal, information of the terminal is registered in the metadata server 102 in association with the user ID. On the other hand, when a user whose user ID is already registered and for whom the terminal is registered as a terminal in use starts using it, the terminal is not repetitively registered in the metadata server 102.

In addition, in the information communication system 100 shown in FIG. 1, it is assumed that a terminal controls another terminal in a remotely controlling manner, or the like. In this case, the controlled terminal inherits the log-in state of the controlling terminal. When a user attempts to control a terminal shared with a group using his or her occupied terminal, the shared terminal logs into the metadata server 102 with the user ID of the user, not as a group, to register, update, and acquire reproduction stop position information of content.

In addition, in the information communication system 100 shown in FIG. 1, reproduction stop position information of content of a user is registered in the metadata server 102 in association with the user ID, but can be used in another terminal registered with respect to the user or a group to which the user belongs.

When a terminal A stops reproducing content A such as a moving image, music, an electronic book, photos (slide show) that can be shared by a plurality of terminals, for example, if the terminal A is in a log-in state as the user A, the terminal A registers the reproduction stop position information in the metadata server 102 in association with the user ID:A. Then, the content can be continuously reproduced using the reproduction stop position information with an occupied terminal and a shared terminal which is logged into with the user ID:A and the group ID:A to which the user A belongs.

In addition, when the terminal A is in a log-in state with the group ID:A of the group A to which the user A belongs, and reproduction of content is stopped, reproduction stop position information is registered in the metadata server 102 in association with the group ID:A. Then, the content can be continuously reproduced using the reproduction stop position information with a shared terminal which is logged into with the group ID:A and an occupied terminal which is logged into with a user ID of each user who belongs to the group A.

In addition, when the terminal A detects an end of the use of the terminal A by the user A during reproduction of content in a log-in state with the group ID:A of the group A to which the user A belongs (for example, when the user A leaving the terminal A is detected), the terminal A registers the reproduction stop position information in the metadata server 102 in association with the user ID:A. Then, the content can be continuously reproduced using the reproduction stop position information with an occupied terminal or a shared terminal which is logged into with the user ID:A and the group ID:A to which the user A belongs.

However, the metadata server 102 prohibits the use of the reproduction stop position information associated with the user ID:A by a terminal which is logged into with a user ID other than the user ID:A and a group ID other than the group to which the user A belongs.

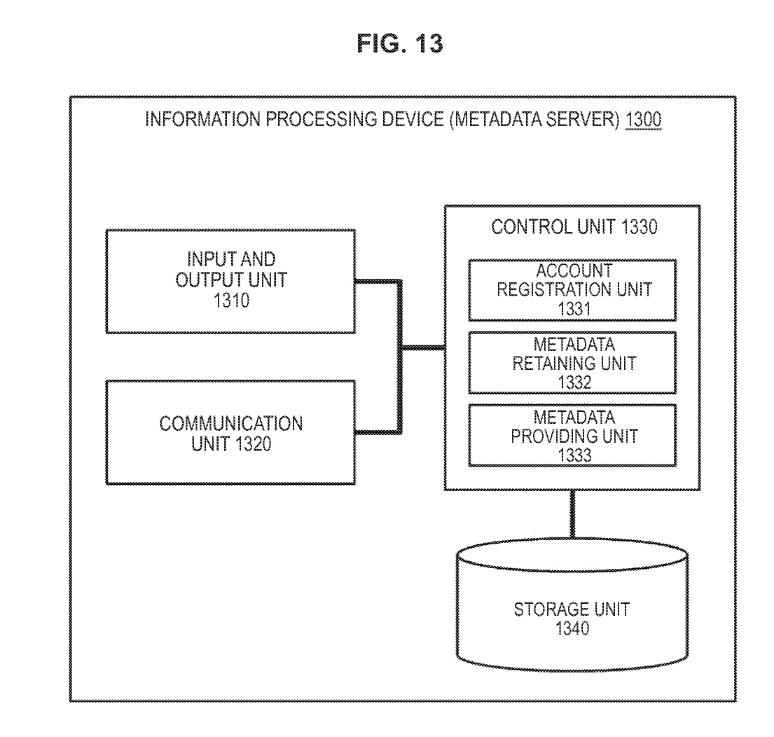

FIG. 13 schematically shows a functional configuration of an information processing device 1200 that operates as the metadata server 102 in the information communication system 100. The information processing device 1200 shown in the drawing is provided with an input and output unit 1310, a communication unit 1320, a control unit 1330, and a storage unit 1340.

The input and output unit 1310 includes an input device such as a keyboard, a mouse, and a touch panel, and an output device such as a display, and a printer.

The communication unit 1320 is connected to a home network via the wireless LAN router 103, and performs communication operations with the content server 101 and the terminals 111 and so on. In addition, the communication unit 1320 may be connected to an external network such as the Internet.

The storage unit 1340 stores software executed by the control unit 1330, programs, and metadata (refer to FIGS. 8 and 9).

The control unit 1330 executes applications and programs that realize predetermined functions of the metadata server so as to realize the functions as an account registration unit 1331, a metadata retaining unit 1332, and a metadata providing unit 1333.

The account registration unit 1331 distributes account information of each user and account information of groups that include a plurality of users to the terminals 111 and so on, and causes the storage unit 1340 to retain the information as metadata.

The metadata retaining unit 1332 receives information of terminals that users or groups use and reproduction stop position information of content from the terminals 111 and so on, and causes the storage unit 1340 to retain the information as metadata in association with account information of corresponding users or groups.

The metadata providing unit 1333 provides the terminals 111 and so on that the users and groups use with reproduction stop position information associated with account information of a user or a group within metadata retained in the storage unit 1340.

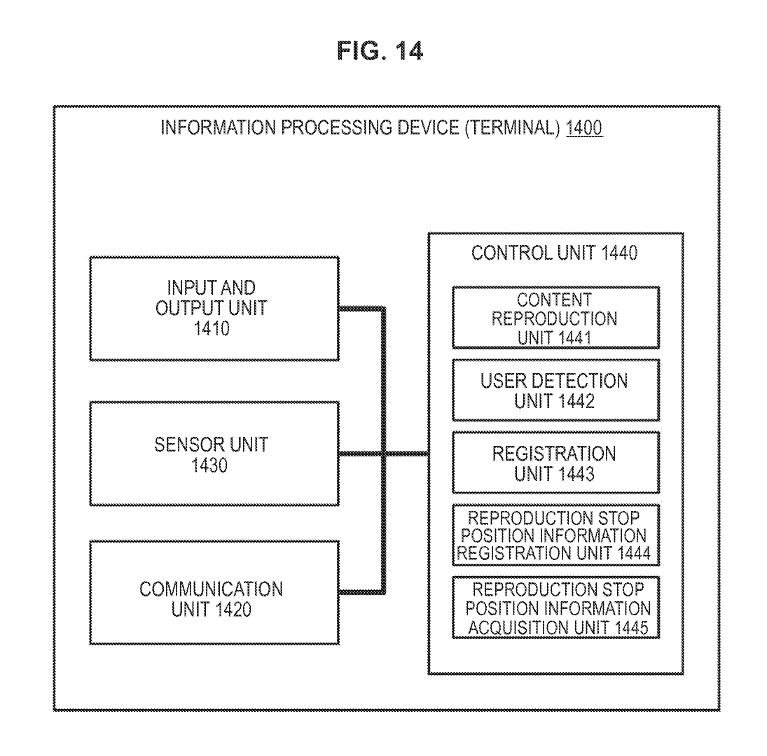

In addition, FIG. 14 schematically shows a functional configuration of an information processing device 1400 that operates as the occupied terminals 111 and so on or the shared terminals 121 and so on in the information communication system 100. The information processing device 1400 shown in the drawing is provided with an input and output unit 1410, a sensor unit 1420, a communication unit 1430, and a control unit 1440.

The input and output unit 1410 includes an input device such as keys, buttons, and a touch panel, and an output device such as a display. The output device is used in outputting reproduced content.

The sensor unit 1420 includes a camera that obtains face images by photographing users, a reader that reads IC cards that users possess, a human-sensing sensor, and the like.

The communication unit 1430 is connected to a home network via the wireless LAN router 103 so as to perform communication operations with the content server 101 and the metadata server 102. The communication unit registers, updates, and reads metadata with respect to the metadata server 102, and requests a content list and reproduction of content (including continuous reproduction) with respect to the content server 101.

The control unit 1440 executes applications and programs that realize predetermined functions of a terminal so as to realize the functions as a content reproduction unit 1441, a user detection unit 1442, a registration unit 1443, a reproduction stop position information registration unit 1444, and a reproduction stop position information acquisition unit 1445.

The content reproduction unit 1441 reproduces content transferred from the content server 101 via the communication unit 1430. When content is continuously reproduced from a position other than the beginning, the content reproduction unit transmits a content reproduction request to the content server 101 with reproduction stop position information of the content received from the metadata server 102.

The user detection unit 1442 detects a user based on a sensor output from the sensor unit 1420. When the sensor unit 1420 is a camera, the user detection unit 1442 extracts a face image from a photographed image, further performs face recognition, and then sets the extracted face image or the face recognition result as personally identifiable information of the detected user. In addition, when the sensor unit 1420 is a reader, the user detection unit 1442 reads personally identifiable information from an IC card that a user possesses. In addition, when the sensor unit 1420 is a human-sensing sensor, the user detection unit 1442 ascertains the presence of an unidentified number of users without obtaining information for identifying the users from a sensor output.

The registration unit 1443 registers users or groups that are detected by the user detection unit 1442 in the metadata server 102, and acquires account information used in logging in and accessing the metadata server 102 by each user or group that uses a corresponding terminal.

The reproduction stop position information registration unit 1444 logs into the metadata server 102 with account information of a user or a group that uses a corresponding terminal to register reproduction stop position information of content of the content reproduction unit 1441 in association with the account information.

When a user or a group that uses a corresponding terminal performs continuous reproduction of content in the content reproduction unit 1441, the reproduction stop position information acquisition unit 1445 logs into the metadata server 102 using corresponding account information to acquire reproduction stop position information of the content associated with the account information.

The characteristics of the embodiments described in the present specification will be summarized as follows:

(1) A terminal that includes or is externally connected to a camera can photograph the face part of a user to ascertain a use condition such as use by an individual user or simultaneous use by a plurality of users using a face recognition function. In addition, during simultaneous use by a plurality of users, when the use condition is monitored, and a user who is out of the visual field of the camera is detected, information that identifies content being reproduced in the terminal and information of the reproduction position upon leaving the visual field are retained in the metadata server 102 in association with the user. Thus, even when a plurality of users use a shared terminal, reproduction stop position information of an individual user can be updated without a special operation.
(2) Reproduction stop position information of content generated during a simultaneous use of a shared terminal in a group that includes a plurality of users is retained in the metadata server 102 in association with the group ID, and then the reproduction stop position information can be read even with a user ID of which the user belongs to the group, not with the group ID.
(3) When reading reproduction stop position information from a terminal, the metadata server 102 enables a simultaneous use by a plurality of users by adopting log-in with a group ID while adopting a log-in scheme in which a user is identified. Thus, it is not necessary for a user who is unfamiliar with consumer AV devices to perform a log-in operation.
(4) A terminal includes or is externally connected to a camera that can photograph the face of a user. When a user or a group logs into the metadata server 102 through a terminal using a user ID or a group ID, an operation by the user can be made unnecessary using a face recognition function.
(5) The metadata server 102 retains reproduction stop position information generated during reproduction of content on an occupied terminal of an individual user in association with the user ID thereof, and the information can be read not only with the user ID of a user but also with the group ID of a group to which the user belongs. Thus, when a user stops reproduction of content halfway on his or her occupied terminal, the content can be continuously reproduced even on a shared terminal of a group to which the user belongs.
(6) When a user pauses reproduction of content on a terminal, the user can continuously reproduce the content with no omissions even he or she shifts to another terminal by causing the metadata server 102 that is a separate device from the original terminal to retain reproduction stop position information thereof.
(7) An operation to continuously reproduce content from a reproduction stop position can be simplified by retaining the place of origin of the content and information that can identify the content itself together in a format that is associated with or implies reproduction stop position information when reproduction of the content is paused on a terminal.

Additionally, the present technology may also be configured as below:

(1) An information processing device including:

an account registration unit that registers account information of a user and account information of a group that includes a plurality of users;

a metadata retaining unit that retains information of a terminal that the user or the group uses and reproduction stop position information of content in association with the account information of the user or the group; and

a metadata providing unit that provides the terminal that the user or the group uses with the reproduction stop position information associated with the account information of the user or the group.

(2) The information processing device according to (1), wherein the metadata retaining unit retains reproduction stop position information received from a terminal that logs in using account information of an individual user in association with the account information of the user, and retains reproduction stop position information received from a terminal that logs in using account information of a group in association with the account information of the group.
(3) The information processing device according to (1), wherein the metadata providing unit provides a terminal that logs in using account information of an individual user with reproduction stop position information associated with the account information of the individual user and reproduction stop position information of a group (or a plurality of groups) associated with the account information of the individual user.
(4) The information processing device according to (1), wherein the metadata providing unit provides a terminal that logs in using account information of a group with reproduction stop position information associated with the account information of the group, reproduction stop position information of an individual user (or a plurality of individual users) associated with the group, and reproduction stop position information of another group (or a plurality of other groups) further associated with the individual user who is associated with the group.
(5) The information processing device according to (1), wherein the metadata retaining unit retains reproduction stop position information along with information on a place of origin of content.
(6) An information processing device including:

a content reproduction unit that reproduces content;

a user detection unit that detects a user;

a registration unit that registers the user detected by the user detection unit in a metadata server to acquire account information;

a reproduction stop position information registration unit that logs into the metadata server using the account information of the user to register reproduction stop position information of the content of the content reproduction unit in association with the account information; and

a reproduction stop position information acquisition unit that logs into the metadata server using the account information of the user to acquire the reproduction stop position information of the content associated with the account information,

wherein the content reproduction unit reproduces the content from a beginning position or the acquired reproduction stop position.

(7) The information processing device according to (6), wherein the registration unit registers a plurality of users detected by the user detection unit in the metadata server as a group to acquire account information of the group.
(8) The information processing device according to (6), wherein the reproduction stop position information acquisition unit logs into the metadata server using account information of an individual user to acquire reproduction stop position information associated with the account information of the individual user and reproduction stop position information of a group (or a plurality of groups) associated with the account information of the individual user.
(9) The information processing device according to (6), wherein the reproduction stop position information acquisition unit logs into the metadata server using account information of a group to acquire reproduction stop position information associated with the account information of the group, reproduction stop position information of an individual user (or a plurality of individual users) associated with the group, and reproduction stop position information of another group (or a plurality of other groups) further associated with the individual user who is associated with the group.
(10) The information processing device according to (6), wherein the reproduction stop position information registration unit logs into the metadata server using account information of a group to register reproduction stop position information in association with the account information of the group in response to a top of reproduction of content that has been viewed and listened to by the group.
(11) The information processing device according to (6), wherein, in response to the user detection unit detecting that a user who is a member of a group is leaving, the reproduction stop position information registration unit logs into the metadata server using account information of the user who is leaving to register reproduction position information at a time of leaving as reproduction stop position information in association with the account information of the user who is leaving.
(12) The information processing device according to (6), wherein, in response to the user detection unit detecting absence of all users of a group, the reproduction stop position information registration unit logs into the metadata server using account information of the group to register reproduction position information at a time when the absence of all the users is detected as reproduction stop position information in association with the account information of the group.
(13) The information processing device according to (6), wherein, while logging into the metadata server using account information of a group, in response to control by a terminal that an individual user who belongs to the group uses, the group is logged out from the metadata server, and logs into the metadata server again using account information of the individual user.
(14) The information processing device according to (13), wherein, in response to a content reproduction request received from a terminal that an individual user who belongs to a group uses, the reproduction stop position information acquisition unit logs into the metadata server using account information of the individual user to acquire reproduction stop position information of content associated with the account information of the individual user.
(15) The information processing device according to (13), wherein, in response to a content reproduction stop request received from a terminal that an individual user who belongs to a group uses, the reproduction stop position information registration unit logs into the metadata server using account information of the individual user to register reproduction stop position information of content in association with the account information of the individual user.
(16) The information processing device according to (6),

wherein the reproduction stop position information acquisition unit acquires reproduction stop position information along with information on a place of origin of content, and

wherein the content reproduction unit identifies content and then continuously reproduces the content from a reproduction stop position using the acquired information on a place of origin.

(17) An information processing method including:

registering account information of a user and account information of a group that includes a plurality of users;

retaining information of a terminal that the user or the group uses and reproduction stop position information of content in association with account information of the user or the group; and

providing the terminal that the user or the group uses with reproduction stop position information associated with the account information of the user or the group.

(18) An information processing method including:

reproducing content;

detecting a user;

registering the user detected in the user detection step in a metadata server to acquire account information;

registering reproduction stop position information of the content in the content reproduction step in association with the account information by logging into the metadata server using the account information of the user; and

acquiring reproduction stop position information of the content associated with the account information by logging into the metadata server using the account information of the user,

wherein, in the content reproduction step, the content is reproduced from a beginning position or the acquired reproduction stop position.

(19) A computer program described in a computer-readable form, the computer program causing a computer to function as:

an account registration unit that registers account information of a user and account information of a group that includes a plurality of users;

a metadata retaining unit that retains information of a terminal that the user or the group uses and reproduction stop position information of content in association with the account information of the user or the group; and

a metadata providing unit that provides the terminal that the user or the group uses with the reproduction stop position information associated with the account information of the user or the group.

(20) A computer program described in a computer-readable form, the computer program causing a computer to function as:

a content reproduction unit that reproduces content;

a user detection unit that detects a user;

a registration unit that registers the user detected by the user detection unit in a metadata server to acquire account information;

a reproduction stop position information registration unit that logs into the metadata server using the account information of the user to register reproduction stop position information of the content of the content reproduction unit in association with the account information; and

a reproduction stop position information acquisition unit that logs into the metadata server using the account information of the user to acquire the reproduction stop position information of the content associated with the account information,

wherein the content reproduction unit reproduces the content from a beginning position or the acquired reproduction stop position.

(21) An information communication system including:

a content server that provides content;

a terminal that is used by an individual user or a group that includes a plurality of users to reproduce the content provided by the content server; and

a metadata server that retains reproduction stop position information of the user and the group in association with account information, and provides the terminal that the user or the group uses with the reproduction stop position information.

Hereinabove, the technology disclosed in the present specification has been described in detail with reference to specific embodiments. However, it should be understood by those skilled in the art that various modifications, combinations, sub-combinations and alterations may occur depending on design requirements and other factors insofar as they are within the scope of the appended claims or the equivalents thereof.

In the present specification, the embodiments in which a family uses content on a home network installed in a household have been described, but the gist of the technology disclosed in the present specification is not limited thereto. The technology disclosed in the present specification can apply in the same manner even to an information communication system in which unidentified individual users use content on a wide area network.

The technology disclosed in the present specification can be used in managing reproduction stop position information of content of various kinds such as moving images, music, electronic books, and photos (slide shows).

In short, the technology disclosed in the present specification has been described in exemplary forms, but the described content of the present specification should not be limitedly interpreted. The claims thereof should be considered to determine the gist of the technology disclosed in the present specification.

The present disclosure contains subject matter related to that disclosed in Japanese Priority Patent Application JP 2012-136383 filed in the Japan Patent Office on Jun. 15, 2012, the entire content of which is hereby incorporated by reference.

What is claimed is:

1. An information processing device comprising:
An account registration unit that registers account information of a user and account information of a group that includes a plurality of users;
a metadata retaining unit that retains information of a terminal that the user or the group uses and reproduction stop position information of content in association with the account information of the user or the group; and
a metadata providing unit that provides the terminal that the user or the group uses with the reproduction stop position information associated with the account information of the user or the group.

2. The information processing device according to claim 1, wherein the metadata retaining unit retains reproduction stop position information received from a terminal that logs in using account information of an individual user in association with the account information of the user, and retains reproduction stop position information received from a terminal that logs in using account information of a group in association with the account information of the group.

3. The information processing device according to claim 1, wherein the metadata providing unit provides a terminal that logs in using account information of an individual user with reproduction stop position information associated with the account information of the individual user and reproduction stop position information of a group (or a plurality of groups) associated with the account information of the individual user.

4. The information processing device according to claim 1, wherein the metadata providing unit provides a terminal that logs in using account information of a group with reproduction stop position information associated with the account information of the group, reproduction stop position information of an individual user (or a plurality of individual users) associated with the group, and reproduction stop position information of another group (or a plurality of other groups) further associated with the individual user who is associated with the group.

5. The information processing device according to claim 1, wherein the metadata retaining unit retains reproduction stop position information along with information on a place of origin of content.

6. An information processing device comprising:
a content reproduction unit that reproduces content;
a user detection unit that detects a user;
a registration unit that registers the user detected by the user detection unit in a metadata server to acquire account information;
a reproduction stop position information registration unit that logs into the metadata server using the account information of the user to register reproduction stop position information of the content of the content reproduction unit in association with the account information; and
a reproduction stop position information acquisition unit that logs into the metadata server using the account information of the user to acquire the reproduction stop position information of the content associated with the account information,
wherein the content reproduction unit reproduces the content from a beginning position or the acquired reproduction stop position.

7. The information processing device according to claim 6, wherein the registration unit registers a plurality of users detected by the user detection unit in the metadata server as a group to acquire account information of the group.

8. The information processing device according to claim 6, wherein the reproduction stop position information acquisition unit logs into the metadata server using account information of an individual user to acquire reproduction stop position information associated with the account information of the individual user and reproduction stop position information of a group (or a plurality of groups) associated with the account information of the individual user.

9. The information processing device according to claim 6, wherein the reproduction stop position information acquisition unit logs into the metadata server using account information of a group to acquire reproduction stop position information associated with the account information of the group, reproduction stop position information of an individual user (or a plurality of individual users) associated with the group, and reproduction stop position information of another group (or a plurality of other groups) further associated with the individual user who is associated with the group.

10. The information processing device according to claim 6, wherein the reproduction stop position information registration unit logs into the metadata server using account information of a group to register reproduction stop position information in association with the account information of the group in response to a top of reproduction of content that has been viewed and listened to by the group.

11. The information processing device according to claim 6, wherein, in response to the user detection unit detecting that a user who is a member of a group is leaving, the reproduction stop position information registration unit logs into the metadata server using account information of the user who is leaving to register reproduction position information at a time of leaving as reproduction stop position information in association with the account information of the user who is leaving.

12. The information processing device according to claim 6, wherein, in response to the user detection unit detecting absence of all users of a group, the reproduction stop position information registration unit logs into the metadata server using account information of the group to register reproduction position information at a time when the absence of all the users is detected as reproduction stop position information in association with the account information of the group.

13. The information processing device according to claim 6, wherein, while logging into the metadata server using account information of a group, in response to control by a terminal that an individual user who belongs to the group uses, the group is logged out from the metadata server, and logs into the metadata server again using account information of the individual user.

14. The information processing device according to claim 13, wherein, in response to a content reproduction request received from a terminal that an individual user who belongs to a group uses, the reproduction stop position information acquisition unit logs into the metadata server using account information of the individual user to acquire reproduction stop position information of content associated with the account information of the individual user.

15. The information processing device according to claim 13, wherein, in response to a content reproduction stop request received from a terminal that an individual user who belongs to a group uses, the reproduction stop position information registration unit logs into the metadata server using account information of the individual user to register reproduction stop position information of content in association with the account information of the individual user.

16. The information processing device according to claim 6,
wherein the reproduction stop position information acquisition unit acquires reproduction stop position information along with information on a place of origin of content, and
wherein the content reproduction unit identifies content and then continuously reproduces the content from a reproduction stop position using the acquired information on a place of origin.

17. An information processing method comprising:
registering account information of a user and account information of a group that includes a plurality of users;
retaining information of a terminal that the user or the group uses and reproduction stop position information of content in association with account information of the user or the group; and
providing the terminal that the user or the group uses with reproduction stop position information associated with the account information of the user or the group.

18. An information processing method comprising:
reproducing content;
detecting a user;
registering the user detected in the user detection step in a metadata server to acquire account information;
registering reproduction stop position information of the content in the content reproduction step in association with the account information by logging into the metadata server using the account information of the user; and
acquiring reproduction stop position information of the content associated with the account information by logging into the metadata server using the account information of the user,
wherein, in the content reproduction step, the content is reproduced from a beginning position or the acquired reproduction stop position.

19. A computer program described in a computer-readable form, the computer program causing a computer to function as:
an account registration unit that registers account information of a user and account information of a group that includes a plurality of users;
a metadata retaining unit that retains information of a terminal that the user or the group uses and reproduction stop position information of content in association with the account information of the user or the group; and
a metadata providing unit that provides the terminal that the user or the group uses with the reproduction stop position information associated with the account information of the user or the group.

20. A computer program described in a computer-readable form, the computer program causing a computer to function as:
a content reproduction unit that reproduces content;
a user detection unit that detects a user;
a registration unit that registers the user detected by the user detection unit in a metadata server to acquire account information;
a reproduction stop position information registration unit that logs into the metadata server using the account information of the user to register reproduction stop position information of the content of the content reproduction unit in association with the account information; and
a reproduction stop position information acquisition unit that logs into the metadata server using the account information of the user to acquire the reproduction stop position information of the content associated with the account information,
wherein the content reproduction unit reproduces the content from a beginning position or the acquired reproduction stop position.

21. An information communication system comprising:
a content server that provides content;
a terminal that is used by an individual user or a group that includes a plurality of users to reproduce the content provided by the content server; and
a metadata server that retains reproduction stop position information of the user and the group in association with account information, and provides the terminal that the user or the group uses with the reproduction stop position information.
